(19) United States
(12) Patent Application Publication
(10) Pub. No.: US 2009/0103770 A1
(43) Pub. Date: Apr. 23, 2009

(54) Image data transmission system and method, and terminal apparatus and management center which constitute transmission side and reception side of the system

(75) Inventors: Kazuo Kuroda, Saitama (JP); Mutsumi Kono, Saitama (JP)

Correspondence Address: YOUNG & THOMPSON, 209 Madison Street, Suite 500, ALEXANDRIA, VA, 22314, US

(73) Assignee: PIONEER CORPORATION, TOKYO (JP)

(21) Appl. No.: 11/920,742

(22) PCT Filed: May 24, 2006
(86) PCT No.: PCT/JP2006/310336

§ 371 Date: Nov. 20, 2007

(30) Foreign Application Priority Data
May 24, 2005 (JP) 2005-150835

(51) Int. Cl. G06K 9/00

(52) U.S. Cl. 382/100

(57) ABSTRACT

An image data transmission system comprises a first terminal device (110) and a second terminal device (210) included in a communication network. (I) The first terminal device (110) includes first processing means (111) for performing such a first operation upon image data as contains an adding operation to add management information containing copyright information and an embedding operation to embed a watermark on the copyright holder, thereby to generate communication data, and first communication means (112) for transmitting communication data. (II) The second terminal (21) includes second communication means (212) for receiving the communication data, and recording means (215) for recording the image data, to which either the communication data or the management information contained in the communication data is added and in which the watermark is embedded, in a recording medium.

### TECHNICAL FIELD

The present invention relates to an image data transmission system which is provided with a first terminal apparatus and a second terminal apparatus, and an image data transmission method, wherein the first terminal apparatus is a personal computer or the like, which is disposed at an overseas photo shop to which electrophotographic data is brought in an overseas destination or the like, and the second terminal apparatus is a personal computer or the like, which is included in the same communication network, such as the Internet, as that in the first terminal apparatus in a home country or the like and which is disposed at a domestic photo shop, as well as such a first terminal apparatus, such a second terminal apparatus, and a management center.

### BACKGROUND ART

There are various suggestions for an image data transmission system which transmits and receives the image data related to electrophotography, through a communication network, such as the Internet.

For example, a patent document 1 suggests a service in which electrophotographic data is converted to a photograph and sent back if the electrophotographic data is uploaded to a predetermined site from a personal computer at home and a payment is made by credit card. A patent document 2 suggests a technology in which an e-mail address and an attached file related to the electrophotographic data are associated. A patent document 3 suggests a concentrated printing system for electrophography. A patent document 4 suggests a technology in which images, which are obtained from an image storage device and which have unique identification information, are organized and managed. A patent document 5 suggests a technology of backup if any of a plurality of printers, which monitor each other, cannot print. A patent document 6 suggests a mechanism of downloading contents whose copyright is protected.

Patent document 1: Japanese Patent Application Laid Open NO. 2001-325082
Patent document 2: Japanese Patent Application Laid Open NO. 2002-157198
Patent document 3: Japanese Patent Application Laid Open NO. 2002-94909
Patent document 4: Japanese Patent Application Laid Open NO. 2001-243321
Patent document 5: Japanese Patent Application Laid Open NO. 2001-290629
Patent document 6: Japanese Patent Application Laid Open NO. 2005-31849

### DISCLOSURE OF INVENTION

### Subject to be Solved by the Invention

As in the Background Art, when the electrophotographic data is transmitted and received through the communication network, such as the Internet, the electrophotographic data is possibly lost in the procedure of the transmission and reception. However, it is general to leave the electrophotographic data on the transmission side, which is a personal computer or the like at home. In particular, the personal computer or the like at home is provided with a hard disk, a recording medium, such as a DVD, or the like, which has several orders of magnitude larger memory capacity than that of a memory card or the like of a digital camera. Thus, it is unnecessary to delete the important electrophotographic data after the transmission, in the first place. Thus, even if the electrophotographic data is lost in the procedure of the transmission and reception, it stops short of losing the electrophotographic data itself.

However, in the case that the electrophotographic data is brought to a shop in an overseas destination or the like, if the electrophotographic data is deleted from a recording medium, such as a memory card, on the faith of a personal computer and a data communication at a shop where the data is brought, the important electrophotographic data is possibly lost, which is a technical problem. In contrast, if the electrophotographic data is not deleted from the recording medium, such as a memory card, just in case, without the faith of the personal computer and the data communication at a shop where the data is brought, the meaning of this action of bringing the data into a shop is halved or almost lost. That is, it is because the main purpose to bring the electrophotographic data on the recording medium, such as a memory card, into a shop in an oversea destination or the like is considered to be only to restore the memory capacity of the recording medium, such as a memory card.

In addition, even if the electrophotographic data is not deleted from the recording medium, such as a memory card, just in case, at a shop where the data is brought, or even if the reception of the electrophotographic data is succeeded on the reception side, there is such a technical problem that the important electrophotographic data is possibly stolen, lost, or the like by hacking.

In view of the aforementioned problems, it is therefore an object of the present invention to provide an image data transmission system and method, which enable the transmission of the electrophotographic data through the communication network, such as the Internet, relatively reliably and relatively efficiently, and an authenticating apparatus and a management center, which constitute the transmission side and the reception side of such a system, respectively.

### Means for Solving the Object

(Image Data Transmission System)

The above object of the present invention can be achieved by a first image data transmission system including a first terminal apparatus and a second terminal apparatus, which are included in a communication network, (I) the first terminal apparatus provided with: a first processing device for performing a first process including an addition process and an embedding process, on image data to be transmitted, to thereby generate communication data, the addition process adding management information, which includes copyright holder information about a copyright holder of the image data to manage the image data, the embedding process embedding watermark about the copyright holder into the image data; and a first communicating device for transmitting the generated communication data through the communication network, (II) the second terminal apparatus provided with: a second communicating device for receiving the transmitted communication data through the communication network; and a recording device for recording the received communication data or the image data to which the management information included in the received communication data is added and in which the watermark is embedded, onto a recording medium.

According to the first image data transmission system of the present invention, the image data is, for example, electrophotographic data (i.e. photographic data generated by taking a picture with a digital camera or video camera). The format may be based on JPEG (Joint Photographic Experts Group) standard, or it may be based on MPEG (Moving Picture Expert Group) standard. The image data is brought to a shop in an overseas travel destination or the like by a user who is the owner of the image data in such a condition that the image data is stored on the recording medium, which is provided with a memory card, a memory stick, or the like.

For example, the first terminal apparatus included in the communication network, such as the Internet, is formed of a personal computer or the like, disposed at a shop in such a travel destination, in terms of hardware. Then, various logical structure elements, which fulfill various functions related to the first terminal apparatus explained next, are embodied by software. On the other hand, the second terminal apparatus, which is included in the communication network, such as the Internet, as in the first terminal apparatus, is formed of a personal computer or the like, disposed at a shop in a user's home country or in a third country (i.e. in another country, which is not the aforementioned overseas nor home country, such as the developing countries which allow low-cost printing), at a collection center, or at a service center. There may be one second terminal apparatus disposed in this manner in the image data transmission system, or a plurality of second terminal apparatuses arranged, as described later. The second terminal apparatus is formed of a personal computer or the like, disposed at such a shop in terms of hardware. Then, various logical structure elements, which fulfill various functions related to the “second” terminal apparatus explained next, are embodied by software.

Firstly, on the first terminal apparatus side, if the image data is brought by a user, the first process is performed on the image data by the first processing device, which is provided with a controller, a memory, and the like. As part of the first process, the management information for managing the image data is added by the addition process. Before or after, or simultaneously with this, the watermark (i.e. digital watermark) about the copyright holder is embedded or inserted by the embedding process into the image data. Incidentally, the embedded watermark here may be image ID which is peculiar to an image, at least related to copyright information. The image ID is ID which is peculiar to the image data which indicates information about the name of the copyright holder, a client who requests the transmission, a registrant, or the like. The image ID may be liked with the management information.

The “management information” here means information which is somehow related to the management information, and information for managing the image data. For example, it includes (i) various user identification information or ID information, which indicates user ID (Identification), name, address, phone number, and the like, and which is to identify a user, a memory card in which the image data is stored, a digital camera related to the generation of the image data, or the like, and (ii) copyright holder management information which clarifies the copyright holder of the image data. Moreover, history information, which indicates a history about recording of data input/output from the management center, a print-out process, disc preparation, or the like, may be included in one portion of the management information. In addition to disc ID information and EDC (Error Detection Code) information, which comply with predetermined types of standards, such as a DVD standard, the information or the like that is at least one portion of disc management information or a file system, which is recorded by a unit of sector, is included in one portion of the management information herein. In other words, preferably, the various management information, such as the user identification information and the copyright holder management information described above, is added to the image data as the management information, which complies with the predetermined types of standards, such as a DVD standard, such that the various management information can be subsequently recorded and reproduced as proper management information as it is (or by slightly modifying it) on the recording medium which complies with the predetermined types of standards, such as a DVD standard.

Such management information may be inputted through an input device which is provided for the first terminal apparatus and which has a key board, a mouse, an input pen, an audio input apparatus, or the like. Alternatively, such management information may be loaded into the first terminal apparatus through an input port in a predetermined standard, from equipment, such as a user's memory card on which the image data is recorded and a user's digital camera. Moreover, such management information may be loaded into the first terminal apparatus through a port in a predetermined standard or by phone, from equipment which is not directly related to the image data, such as a user's mobile phone and mobile device.

In addition, such management information may be updated, as occasion demands, on the second terminal apparatus side and the management center side after it is added by the first processing device. For example, the management information may be updated in various circumstances in accordance with the status of the image data transmitted and received through the communication network, in accordance with a processing process performed on the image data, or in accordance with the individual circumstances of the second terminal apparatus side, or the like.

On the other hand, the “watermark” is electrophotographic data which is a different type from that of the image data embedded or inserted in predetermined points of the image data. The watermark is also referred to as digital watermark. Here, predetermined types of information, such as text information and digital information related to the image data, e.g. the name of the copyright holder, identification number, or the like, is embedded into the image data as the watermark such that some observer, who observes the images corresponding to the image data on a display, can hardly or cannot visually recognize it.

The watermark may be also updated, as occasion demands, on the second terminal apparatus side and the management center side after it is embedded by the first processing device. For example, the management information may be updated in various circumstances in accordance with the status of the image data transmitted and received through the communication network, in accordance with a processing process performed on the image data, or in accordance with the individual circumstances of the second terminal apparatus side, or the like. For example, the watermark, which indicates the number of copy generations in accordance with where the image data is in a generational order of copy, may be updated in each time of the data copy on the second terminal apparatus and on the management center. For example, in the case that mutual authentication can be performed between the first terminal apparatus side and the second terminal apparatus side before the transmission and reception of the communication data are started, the watermark with a generation, i.e. generation management information, may be not updated if the data is moved, and the watermark with the generation may be updated or added if the data is copied. On the other hand, in the case that mutual authentication cannot be performed before the transmission and reception of the communication data are started, the data move is regarded as the data copy, and the watermark with the generation may be updated or added.

Moreover, for example, if the communication data is transmitted and received for the first time, e.g. if the watermark with the generation is not embedded, the watermark with the generation (i.e. the generation management information) may be embedded into all the image data.

In this manner, the communication data is generated by the first processing process including the addition process and the embedding process.

Incidentally, for example, before or after or simultaneously with the addition of the management information, as described above, or before or after or simultaneously with the embedding of the watermark, a first error correction code for performing first error correction on the image data in restoring is added to the image data. The first error correction code is an ECC (Error Correction Code) which complies with the predetermined types of standards, such as a DVD standard. Then, in the format process, moreover, an interleaving process, an encryption process, or the like which complies with a DVD standard or the like may be performed on the image data. In addition, the image data on which the first process is performed by the first processing device as described above is divided and packaged into fixed-data-length data package units, to thereby generate n data packages, which are typically a plurality of or many data packages (wherein one data package is also possible if the image data has a small size). Moreover, a second error correction code for performing second error correction in restoring the data packages may be added to each of the generated n data packages, by using the first processing device.

After that, by using the first communicating device, which is provided with a modem or the like, after the authentication between the first and the second terminal apparatuses is directly performed between the two apparatus terminals, or with relaying a management center described later, through the communication network, such as the Internet and a leased line network, the communication data generated as described above is transmitted to the second terminal apparatus through the communication network. Alternatively, by using the first communicating device, after the authentication between the first terminal apparatus and the management center described later is performed through the communication network, the communication data generated as described above is transmitted to the management center through the communication network. The first terminal apparatus is typically provided with a first authenticating apparatus which can perform the authentication with the second terminal apparatus or the management center. In the same manner, the second terminal apparatus is typically provided with a second authenticating apparatus which can perform the authentication with the first terminal apparatus or the management center. As the authentication method here, the existing various authentication methods can be applied in which a password and code language are transmitted and received, for example. Thus, preferably, the first and second communicating devices firstly perform the authentication process by transmitting and receiving authentication information for the authentication, which is formed of at least one portion of the management information, or another authentication information before the transmission and reception of the communication data, and if they cannot authenticate each other, they stop the subsequent process.

On the other hand, on the second terminal apparatus side, after the authentication with the first communicating apparatus or the management center is performed, the communication data is received by the second communicating device, which is provided with a modem or the like, directly from the first terminal apparatus or with relaying the management center, through the communication network.

Then, the received communication data or the image data to which the management information included in the received communication data is added and in which the watermark is embedded is recorded onto the recording medium, such as a DVD and an optical disc, by the recording device, which is provided with a controller, an optical pickup, and the like. At this time, the management information and the watermark may be updated, as occasion demands, in accordance with circumstances, as described above, and then recorded onto the recording medium.

At this time, preferably, if the management information is added to the image data in compliance with the standard of the recording medium, such as a DVD standard, in advance, then, it is recorded onto the recording medium with the image data and the first error correction code described above, as it is (i.e. with holding the relationship with the image data) or after it is slightly modified, added, or updated. In the same manner, if the watermark is embedded in the image data in accordance with the standard of the recording medium, such as a DVD standard, in advance, then it is also recorded onto the recording medium with the image data as it is (i.e. with holding the relationship with the image data) or after it is slightly modified, added, or updated. By these, when the image data recorded on the recording medium is restored (in other words, reproduced) later, the management information, which is added in advance on the first terminal apparatus side, and the watermark, which is embedded in advance, can be used at least partially, so that it is possible to improve the efficiency as a whole.

Incidentally, the recording may be performed by the recording device after a modulation process, such as 8-16 modulation, is performed. (Incidentally, the transmission may be performed after the 8-16 modulation is performed on the first terminal apparatus side; however, in this case, the data to be transmitted is approximately doubled, so that it is advantageous to perform the 8-16 modulation on the second terminal apparatus.)

After that, at a shop in which the second terminal apparatus is disposed, various related services are performed, such as holding and delivering the recording medium, on which the image data having the watermark embedded is recorded with a part or all of the management information, printing out based on this, and delivering it.

As described above, since there is the copyright holder information in the management information and there is the watermark in the image data, appropriate protection is possible even if the image data, such as electrophotographic data which is related to an individual's privacy or which accompanies a copyright with a high proprietary nature, is stolen or lost in the process of its transmission and storage through the communication network, such as the Internet. For example, even if it is stolen or lost, because the image data has the watermark in a predetermined position, it can be judged by a legitimate copyright holder whether a copy is legal or illegal. At this time, a legitimate relation of right or legal relation, such as who the copyright related to the image data shall belong to, is clarified from the association between the watermark embedded in the image data and the copyright holder information included in the management information. For example, a manager and an owner can be surely proved by ensuring the relationship between the watermark and the copyright holder information, with regard to the communication data which is being transmitted, or the image data with the watermark which will be stored and recorded later and with the management information. In other words, it can be constructed to have a function of ensuring the relationship between the copyright holder indicated by the watermark and the copyright holder or owner indicated by the copyright holder information in the management information, at a shop in which the second terminal apparatus is disposed and the management center.

Consequently, it is possible to transmit the electrophotographic data through the communication network, such as the Internet, relatively highly reliably and relatively efficiently, particularly from the viewpoint of copyright protection. Thus, a shop in an overseas travel destination or the like to which the image data is brought by a user can realize such a service that the image data, such as the received electrophotographic data, is delivered to another shop in the user's home country or a third country or the like, directly or with relaying the management center. Moreover, it is also possible to realize such a service that a DVD and a print can be delivered by the another shop to the user's home in the end.

The above object of the present invention can be achieved by a second image data transmission system including a first terminal apparatus and a second terminal apparatus, which are included in a communication network, (I) the first terminal apparatus provided with: a first processing device for performing a first process including an addition process and an embedding process, on image data to be transmitted, to thereby generate communication data, the addition process adding management information for managing the image data, the embedding process embedding watermark with a generation into the image data, the watermark being about a copyright holder of the image data and having information which indicates where the image data is in a generational order of copy; and a first communicating device for transmitting the generated communication data through the communication network, (II) the second terminal apparatus provided with: a second communicating device for receiving the transmitted communication data through the communication network; a second processing device for updating the watermark with the generation, which is included in the received communication data; and a recording device for recording the image data in which the watermark with the generation, which is updated by the second processing device, is embedded and to which the management information is added, onto a recording medium.

According to the second image data transmission system of the present invention, as in the first image data transmission system of the present invention, the image data is, for example, electrophotographic data, and each of the first terminal apparatus, the second terminal apparatus, and the management center, which are included in the communication network, such as the Internet, is formed of a personal computer or the like.

Firstly, on the first terminal apparatus side, if the image data is brought by a user, the first process is performed on the image data by the first processing device, which is provided with a controller, a memory, and the like. As part of the first process, the management information for managing the image data is added by the addition process. Before or after, or simultaneously with this, the watermark with the generation about the copyright holder is embedded or inserted by the embedding process into the image data.

The “management information” is the same as that in the aforementioned first image data transmission system; however, it is not necessary whether or not the management information includes the aforementioned copyright holder information.

On the other hand, “watermark” is the same as that in the aforementioned first image data transmission system; however, it is particularly the “watermark with the generation” having the information which indicates where the image data is in a generational order of copy;

As described above, the communication data is generated by the first processing including the addition process and the embedding process.

After that, by using the first communicating device, which is provided with a modem or the like, the authentication between the first and the second terminal apparatuses is directly performed between the two apparatus terminals, or with relaying the management center described later, through the communication network, such as the Internet and a leased line network. Then, the communication data generated as described above is transmitted to the second terminal apparatus through the communication network. Alternatively, by using the first communicating device, after the authentication between the first terminal apparatus and the management center described later is performed through the communication network, the communication data generated as described above is transmitted to the management center through the communication network.

On the other hand, on the second terminal apparatus side, after the authentication with the first communicating apparatus or the management center is performed, the communication data is received by the second communicating device, which is provided with a modem or the like, directly from the first terminal apparatus or with relaying the management center, through the communication network.

Then, the watermark with the generation, which is included in the received communication data, is updated by the second processing device, which is provided with a controller, a memory, and the like. For example, the watermark with the generation is updated like the zero generation→the first generation→the second generation, and so on, in each time of the data copy on the second terminal apparatus. In addition, the management information is also updated in the case of the data copy on the management center described later.

After that, the image data in which the watermark with the generation, which is updated by the second processing device, is embedded and to which the updated or not-updated management information is added is recorded onto the recording medium, such as a DVD and an optical disc, by the recording device, which is provided with a controller, an optical pickup, and the like.

At this time, preferably, if the management information is added to the image data in compliance with the standard of the recording medium, such as a DVD standard, in advance, then, it is recorded onto the recording medium with the image data and the first error correction code described above, as it is (i.e. with holding the relationship with the image data) or after it is slightly modified, added, or updated. In the same manner, if the watermark is embedded in the image data in accordance with the standard of the recording medium, such as a DVD standard, in advance, then it is also recorded onto the recording medium with the image data as it is (i.e. with holding the relationship with the image data) or after it is slightly modified, added, or updated. By these, when the image data recorded on the recording medium is restored (in other words, reproduced) later, the management information, which is added in advance on the first terminal apparatus side, and the watermark, which is embedded in advance, can be used at least partially, so that it is possible to improve the efficiency as a whole.

After that, at a shop in which the second terminal apparatus is disposed, various related services are performed, such as holding and delivering the recording medium, on which the image data having the watermark embedded is recorded with a part or all of the management information, printing out based on this, and delivering it.

As described above, since there is the watermark with the generation in the image data, appropriate protection is possible even if the image data, such as electrophotographic data which is related to an individual's privacy or which accompanies a copyright with a high proprietary nature, is stolen or lost in the process of its transmission and storage through the communication network, such as the Internet. For example, even if it is stolen or lost, because the image data has the watermark with the generation in a predetermined position, it can be judged by a legitimate copyright holder whether a copy is legal or illegal, including how many data copies preceded before it. At this time, a legitimate relation of right or legal relation, such as who the copyright related to the image data shall belong to, is clarified from the association between the watermark embedded in the image data and the copyright holder information included in the management information.

Consequently, it is possible to transmit the electrophotographic data through the communication network, such as the Internet, relatively highly reliably and relatively efficiently, particularly from the viewpoint of copyright protection.

Incidentally, in the case that the mutual authentication can be performed between the first terminal apparatus side and the second terminal apparatus side, between the first terminal apparatus side and the management center, or between the second terminal apparatus side and the management center, before the transmission and reception of the communication data are started, the watermark with the generation, i.e. the generation management information, may be not updated if the data is moved, and the watermark with the generation may be updated or added if the data is copied. On the other hand, in the case that mutual authentication cannot be performed before the transmission and reception of the communication data are started, the data move is regarded as the data copy, and the watermark with the generation may be updated or added.

Moreover, if the communication data is transmitted and received for the first time, e.g. if the watermark with the generation is not embedded, the watermark with the generation (i.e. the generation management information) may be embedded into all the image data.

In one aspect of the second image data transmission system of the present invention, the communication network further includes a management center, the management center is provided with: (a) a third communicating device for receiving the communication data transmitted from the first communicating device through the communication network; and (b) a third processing device for updating the watermark with the generation, which is included in the received communication data, the third communicating device newly transmits the image data in which the watermark with the generation, which is updated by the third processing device, is embedded and to which the management information is added, as the communication data, and the second communicating device receives the communication data transmitted from the third transmitting device, in a form of relaying the management center through the communication network.

According to this aspect, the communication data, which is formed of the image data in which the watermark with the generation is embedded, is transmitted from the first terminal apparatus to the second terminal apparatus, with relaying the management center. Here, in particular, at the management center, the watermark with the generation is updated by the third processing device, which is provided with a controller, a memory, and the like. Therefore, with regard to the watermark with the generation, if the data is copied at the management center, it is updated like the zero generation→the first generation. After that, the image data in which the watermark with the generation, which is updated by the second processing device, is embedded and to which the updated or not-updated management information is added is transmitted to the second terminal apparatus through the third communicating device. After that, with regard to the watermark with the generation, if the data is copied at the management center, it is updated like the first generation→the second generation this time.

Incidentally, with regard to the aspect of updating the information which indicates the generation, the updating may be performed by rewriting or additionally writing.

As described above, since the image data has therein the watermark with the generation, which is updated at the management center with a function as a relay station, it is possible to appropriately protect the image data, such as the electrophotographic data which is related to an individual's privacy or which accompanies a copyright with a high proprietary nature.

The above object of the present invention can be achieved by a third image data transmission system including a first terminal apparatus and a second terminal apparatus, which are included in a communication network, (I) the first terminal apparatus provided with: a first processing device for performing a first process including an addition process, on image data to be transmitted, to thereby generate communication data, the addition process adding management information, which includes processing instruction information which gives an instruction to perform a processing process to be performed on the image data to manage the image data; and a first communicating device for transmitting the generated communication data through the communication network, (II) the second terminal apparatus provided with: a second communicating device for receiving the transmitted communication data through the communication network; a second processing device for performing the processing process indicated by the processing instruction information, on the image data in the received communication data; and a recording device for recording the image data on which the processing process is performed, onto a recording medium in such a form that the management information is added.

According to the third image data transmission system of the present invention, as in the first image data transmission system of the present invention, the image data is, for example, electrophotographic data, and each of the first terminal apparatus and the second terminal apparatus, which are included in the communication network, such as the Internet, is formed of a personal computer or the like.

Firstly, on the first terminal apparatus side, if the image data is brought by a user, the first process is performed on the image data by the first processing device, which is provided with a controller, a memory, and the like. As part of the first process, the management information for managing the image data is added by the addition process. Before or after, or simultaneously with this, the watermark about the copyright holder may be embedded or inserted by the embedding process into the image data.

The “management information” is the same as that in the aforementioned first image data transmission system; however, the presence of the “processing instruction information” is necessary. For example, the processing process instructed by the processing instruction information means some process performed on the image data to increase its added value, such as adding appropriate background music to the image data, like adding music in case of a slide show, adding an appropriate background image and image data which indicates a display image to the image indicated by the image data, or the like, and further specific identification information about the music to be added (e.g. song title), identification information about the background image, and the like.

As described above, the communication data is generated by the first processing including the addition process.

Then, the communication data to which the management information including the processing instruction information is added in this manner is transmitted by the first communicating device through the communication network, and it is received by the second communicating device on the second terminal apparatus.

On the other hand, on the second terminal apparatus side, after the authentication with the first communicating apparatus or the management center is performed, the communication data is received by the second communicating device, which is provided with a modem or the like, directly from the first terminal apparatus or with relaying the management center, through the communication network.

Then, the image data included in the received communication data is processed by the second processing device, which is provided with a controller, a memory, and the like, in accordance with the processing instruction information included in the management information, which is added to the image data. For example, background music is added, a background image and a display image are added. When such a processing process is performed, the management information may be updated in accordance with the processing process which is performed on the image data.

After that, the image data, on which the processing process is performed by the second processing device, is recorded onto the recording medium, such as a DVD and an optical disc, by the recording device, which is provided with a controller, an optical pickup, and the like. Thus, the image data of higher added value than that of the original image data is provided in a form of a DVD or the like at a shop or the like in which the second terminal apparatus is disposed.

As described above, since the management information including the processing instruction information is added to the image data, it is unnecessary to transmit, e.g., music information which is necessary to perform the processing process, with the image data. Transmitting content information, such as the music information for the processing process, with the image data, increases the amount of transmission, so that it is hardly possible to perform the quick or efficient transmission. In contrast, if an enormous amount of data for the processing process is intensively prepared in advance on the second terminal apparatus side, then, the processing process can be performed quickly and efficiently by using the enormous amount of data for the processing process prepared in advance, as occasion demands, in accordance with the processing instruction information.

As a result, it is possible to transmit the electrophotographic data through the communication network, such as the Internet, relatively highly reliably and relatively efficiently.

The above object of the present invention can be achieved by a fourth image data transmission system including a first terminal apparatus, a second terminal apparatus, and a management center, which are included in a communication network, (I) the first terminal apparatus provided with: a first processing device for performing a first process including an addition process, on image data to be transmitted, to thereby generate communication data, the addition process adding management information, which includes processing instruction information which gives an instruction to perform a processing process to be performed on the image data to manage the image data; and a first communicating device for transmitting the generated communication data through the communication network, (II) the second terminal apparatus provided with: a second communicating device for receiving the transmitted communication data through the communication network; and a recording device for recording the received communication data, onto a recording medium, (III) the management center provided with: a third communicating device for receiving the communication data transmitted from the first communicating device, through the communication network; and a third processing device for performing the processing process indicated by the processing instruction information, on the image data in the received communication data, the third communicating device newly transmitting the image data on which the processing process is performed and to which the management information is added, as the communication data, the second communicating device receiving the communication data transmitted from the third transmitting device, in a form of relaying the management center through the communication network.

According to the fourth image data transmission system of the present invention, as in the first image data transmission system of the present invention, the image data is, for example, electrophotographic data, and each of the first terminal apparatus, the second terminal apparatus, and the management center, which are included in the communication network, such as the Internet, is formed of a personal computer or the like.

Firstly, on the first terminal apparatus side, if the image data is brought by a user, the first process is performed on the image data by the first processing device, which is provided with a controller, a memory, and the like. As part of the first process, the management information for managing the image data is added by the addition process. Before or after, or simultaneously with this, the watermark about the copyright holder may be embedded or inserted by the embedding process into the image data.

The “management information” is the same as that in the aforementioned first image data transmission system; however, the presence of the “processing instruction information” is necessary. That is, it is the same as in the case of the aforementioned third image transmission system in that the management information includes the processing instruction information.

As described above, the communication data is generated by the first processing including the addition process.

Then, the communication data to which the management information including the processing instruction information is added as described above is transmitted by the first communicating device through the communication network, and it is received by the third communicating device on the management center.

On the other hand, on the management center side, after the authentication with the first communicating device is performed, the communication data is received by the third communicating device, which is provided with a modem or the like, through the communication network from the first terminal apparatus.

Then, the image data included in the received communication data is processed by the third processing device, which is provided with a controller, a memory, and the like, in accordance with the processing instruction information included in the management information, which is added to the image data. For example, background music is added, a background image and a display image are added. When such a processing process is performed, the management information may be updated in accordance with the processing process which is performed on the image data.

After that, the image data, which is processed by the third processing device, is transmitted by the third communicating device through the communication network, and it is received by the second communicating device on the second terminal apparatus.

On the other hand, on the second terminal apparatus side, after the authentication with the management center is performed, the communication data is received by the second communicating device, which is provided with a modem or the like, through the communication network from the first terminal apparatus with the relaying the management center.

After that, the image data included in the received communication data is recorded onto the recording medium, such as a DVD and an optical disc, by the recording device, which is provided with a controller, an optical pickup, and the like. Thus, the image data of higher added value than that of the original image data is provided in a form of a DVD or the like at a shop or the like in which the second terminal apparatus is disposed.

As described above, since the management information including the processing instruction information is added to the image data, it is unnecessary to transmit, e.g., music information which is necessary to perform the processing process, with the image data. Transmitting content information, such as the music information for the processing process, with the image data, increases the amount of transmission, so that it is hardly possible to perform the quick or efficient transmission. In contrast, if an enormous amount of data for the processing process is intensively prepared in advance on the management center side, then, the processing process can be performed quickly and efficiently by using the enormous amount of data for the processing process prepared in advance, as occasion demands, in accordance with the processing instruction information.

As a result, it is possible to transmit the electrophotographic data through the communication network, such as the Internet, relatively highly reliably and relatively efficiently.

Incidentally, in the case of the present invention, the management center may be provided with a storing device for storing the management information, the communication data received by the third communicating device in association with the management information, or the communication data received by the communicating device on which the processing process is performed. By virtue of such construction, uniform management can be performed at the management center on the image data to which background music is added, or the like.

In addition, in another aspect of the first to fourth image data transmission systems of the present invention, the first processing device may perform an encryption process on the image data or the communication data, and the second processing device or the management center may perform a decryption process corresponding to the encryption process, on the received communication data. By virtue of such construction, the confidentiality of the communication data, which is transmitted and received through the communication network, such as the Internet, can be significantly increased by the encryption process.

(First Terminal Apparatus)

The above object of the present invention can be achieved by a first terminal apparatus, which constitutes each of the aforementioned first to third image data transmission systems of the present invention (including its various aspects), by being included in a communication network with a second terminal apparatus.

The first terminal apparatus of the present invention can establish any of the aforementioned first to third image data transmission systems of the present invention. By this, it is possible to transmit the electrophotographic data through the communication network, such as the Internet, relatively highly reliably and relatively efficiently.

(Second Terminal Apparatus)

The above object of the present invention can be achieved by a second terminal apparatus, which constitutes the aforementioned second or third image data transmission system of the present invention (including its various aspects), by being included in a communication network with a first terminal apparatus.

The second terminal apparatus of the present invention can establish the aforementioned second or third image data transmission system of the present invention. By this, it is possible to transmit the electrophotographic data through the communication network, such as the Internet, relatively highly reliably and relatively efficiently.

(Managing Apparatus)

The above object of the present invention can be achieved by a managing apparatus included in a communication network with a first terminal apparatus and a second terminal apparatus, the first terminal apparatus performing a first process including an addition process, on image data to be transmitted, to thereby generate and transmit communication data, the addition process adding management information, which includes processing instruction information which gives an instruction to perform a processing process to be performed on the image data, the managing apparatus provided with: a third communicating device for receiving the communication data transmitted from the first communicating device, through the communication network; and a third processing device for performing the processing process indicated by the processing instruction information, on the image data in the received communication data, the third communicating device newly transmitting the image data on which the processing process is performed and to which the management information is added, as the communication data.

The managing apparatus of the present invention can establish the aforementioned fourth image data transmission system of the present invention, as the management center. By this, it is possible to transmit the electrophotographic data through the communication network, such as the Internet, relatively highly reliably and relatively efficiently.

(Image Data Transmission Method)

The above object of the present invention can be achieved by a first image data transmission method performed in an image data transmission system including a first terminal apparatus and a second terminal apparatus, which are included in a communication network, (I) what are performed on the first terminal apparatus being: a first processing process of performing a first process including an addition process and an embedding process, on image data to be transmitted, to thereby generate communication data, the addition process adding management information, which includes copyright holder information about a copyright holder of the image data to manage the image data, the embedding process embedding watermark about the copyright holder into the image data; and a first communicating process of transmitting the generated communication data through the communication network, (II) what are performed on the second terminal apparatus being: a second communicating process of receiving the transmitted communication data through the communication network; and a recording process of recording the received communication data or the image data to which the management information included in the received communication data is added and in which the watermark is embedded, onto a recording medium.

The above object of the present invention can be achieved by a second image data transmission method performed in an image data transmission system including a first terminal apparatus and a second terminal apparatus, which are included in a communication network, (I) what are performed on the first terminal apparatus being: a first processing process of performing a first process including an addition process and an embedding process, on image data to be transmitted, to thereby generate communication data, the addition process adding management information for managing the image data, the embedding process embedding watermark with a generation into the image data, the watermark being about a copyright holder of the image data and having information which indicates where the image data is in a generational order of copy; and a first communicating process of transmitting the generated communication data through the communication network, (II) what are performed on the second terminal apparatus being: a second communicating process of receiving the transmitted communication data through the communication network; a second processing process of updating the watermark with the generation, which is included in the received communication data; and a recording process of recording the image data in which the watermark with the generation, which is updated by the second processing process, is embedded and to which the management information is added, onto a recording medium.

The above object of the present invention can be achieved by a third image data transmission method performed in an image data transmission system including a first terminal apparatus and a second terminal apparatus, which are included in a communication network, (I) what are performed on the first terminal apparatus being: a first processing process of performing a first process including an addition process, on image data to be transmitted, to thereby generate communication data, the addition process adding management information, which includes processing instruction information which gives an instruction to perform a processing process to be performed on the image data to manage the image data; and a first communicating process of transmitting the generated communication data through the communication network, (II) what are performed on the second terminal apparatus being: a second communicating process of receiving the transmitted communication data through the communication network; a second processing process of performing the processing process indicated by the processing instruction information, on the image data in the received communication data; and a recording process of recording the image data on which the processing process is performed, onto a recording medium in such a form that the management information is added.

The above object of the present invention can be achieved by a fourth image data transmission method performed in an image data transmission system including a first terminal apparatus, a second terminal apparatus, and a management center, which are included in a communication network, (I) what are performed on the first terminal apparatus being: a first processing process of performing a first process including an addition process, on image data to be transmitted, to thereby generate communication data, the addition process adding management information, which includes processing instruction information which gives an instruction to perform a processing process to be performed on the image data to manage the image data; and a first communicating process of transmitting the generated communication data through the communication network, (II) what are performed on the second terminal apparatus being: a second communicating process of receiving the transmitted communication data through the communication network; and a recording process of recording the received communication data, onto a recording medium, (III) what are performed on the management center being: a third communicating process of receiving the communication data transmitted from the first communicating process, through the communication network; and a third processing process of performing the processing process indicated by the processing instruction information, on the image data in the received communication data, the third communicating process newly transmitting the image data on which the processing process is performed and to which the management information is added, as the communication data, the second communicating process receiving the communication data transmitted from the third transmitting process, in a form of relaying the management center through the communication network.

According to the first to fourth image data transmission methods of the present invention, as in the case of each of the aforementioned first to fourth image data transmission systems of the present invention, it is possible to transmit the electrophotographic data through the communication network, such as the Internet, relatively highly reliably and relatively efficiently.

Incidentally, the first to fourth image data transmission methods of the present invention can employ various aspects corresponding to those of the aforementioned first to fourth image data transmission systems of the present invention.

These effects and other advantages of the present invention will become more apparent from the following embodiments.

As explained above in details, each of the first to fourth image data transmission systems of the present invention is provided with: the first terminal apparatus provided with the first processing device; and the second terminal provided with the second processing device and the recording device, or the like. Thus, it is possible to transmit the electrophotographic data, relatively highly reliably and relatively efficiently. The first terminal apparatus of the present invention is provided with the first processing device. Thus, it can establish the image data transmission system of the present invention. By this, it is possible to transmit the electrophotographic data, relatively highly reliably and relatively efficiently. The second terminal apparatus of the present invention is provided with the second processing device and the recording device. Thus, it can establish the image data transmission system of the present invention. By this, it is possible to transmit the electrophotographic data, relatively highly reliably and relatively efficiently. The management center of the present invention is provided with the third processing device. Thus, it can establish the image data transmission system of the present invention. By this, it is possible to transmit the electrophotographic data, relatively highly reliably and relatively efficiently. Moreover, in each of the first to fourth image data transmission methods of the present invention, the first processing process is performed on the first terminal apparatus, and the second processing process is performed on the second terminal apparatus. Thus, it is possible to transmit the electrophotographic data, relatively highly reliably and relatively efficiently.

### BRIEF DESCRIPTION OF DRAWINGS

FIG. 1 is a conceptual view showing the basic structure of an image data transmission system in a first embodiment.

FIG. 2 is a block diagram showing the basic structure of a first terminal apparatus in the first embodiment.

FIG. 3 is a block diagram showing the basic structure of a second terminal apparatus in the first embodiment.

FIG. 4 is a flowchart showing the operation principle of the first terminal apparatus side in the first embodiment.

FIG. 5 is a conceptual view showing the structure of communication data in the first embodiment.

FIG. 6 is a view showing the concept as in FIG. 5 in a modified example of the first embodiment.

FIG. 7 is a flowchart showing the operation principle of the second terminal apparatus side in the first embodiment.

FIG. 8 is a conceptual view showing the basic structure of an image data transmission system in a second embodiment.

FIG. 9 is a block diagram showing the basic structure of a management center in the second embodiment.

FIG. 10 is a flowchart showing the operation principle of the first terminal apparatus and the management center in the second embodiment.

FIG. 11 is a block diagram showing the basic structure of a management center in a third embodiment.

FIG. 12 is a flowchart showing the operation principle of the first terminal apparatus in the third embodiment.

FIG. 13 is a view showing the concept as in FIG. 5 in the third embodiment.

FIG. 14 is a view showing the concept as in FIG. 6 in a modified example of the third embodiment.

FIG. 15 is a flowchart showing the operation principle of the management center in the third embodiment.

### DESCRIPTION OF REFERENCE CODES

50 management information
60, 62 data package
80 management center information
110 first terminal apparatus
111 first processing device
112 first communication device
210 second terminal apparatus
211 second processing device
212 second communication device
215 recording device
216 status information generation device
217 selection device
500 the Internet
ECC1 first error correction code
ECC2 second error correction code

### BEST MODE FOR CARRYING OUT THE INVENTION

Hereinafter, the best mode for carrying out the present invention will be explained in each embodiment in order with reference to the drawings.

### First Embodiment

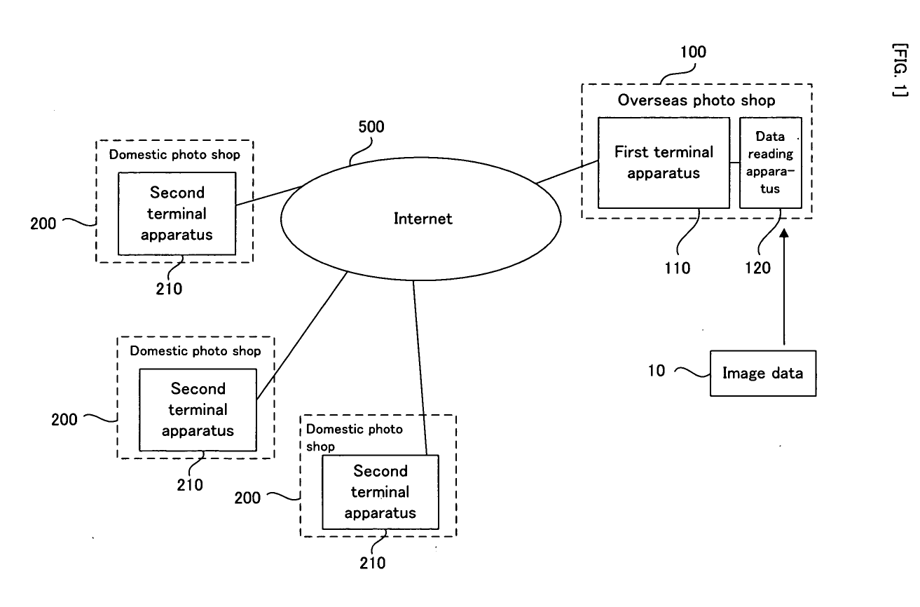

Firstly, with reference to FIG. 1 to FIG. 7, the image data transmission system in the first embodiment of the present invention will be explained.

(1-1) Basic Structure

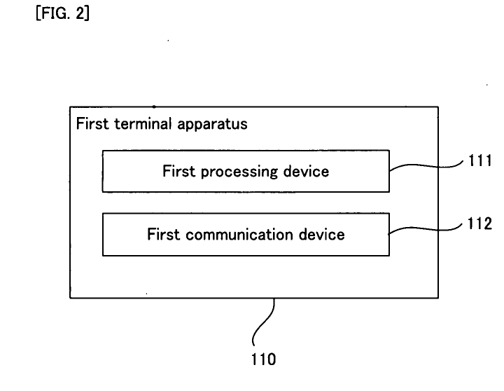

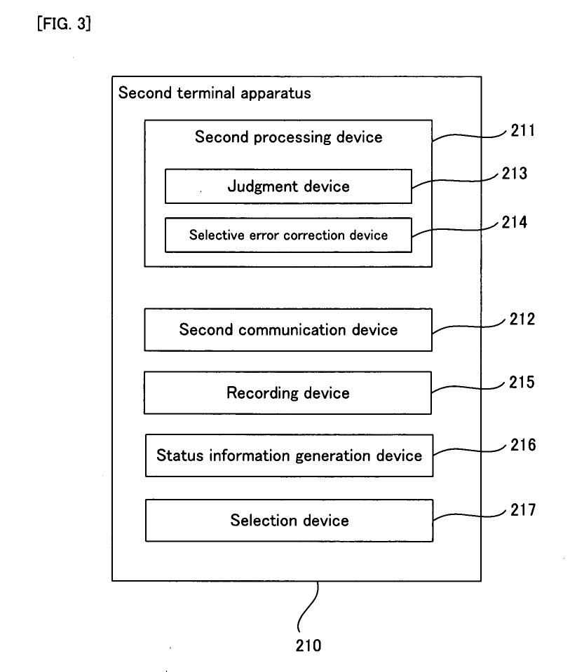

With reference to FIG. 1 to FIG. 3, the basic structure of the image transmission system in the first embodiment of the present invention will be explained. FIG. 1 is a conceptual view showing the basic structure of the image data transmission system in the first embodiment. FIG. 2 is a block diagram showing the basic structure of a first terminal apparatus in the first embodiment. FIG. 3 is a block diagram showing the basic structure of a second terminal apparatus in the first embodiment.

In the image data transmission system in the first embodiment, the following case is exemplified: image data is brought to a shop in an overseas destination or the like by a user, who is the owner of the image data, in such a condition that the image data is stored on a recording medium provided with a memory card, a memory stick, or the like. Incidentally, it may be brought in such a condition that the image data is stored on a memory medium, such as a hard disk and a DVD, built in a digital camera, for example.

As shown in FIG. 1, the image data transmission system in the first embodiment is mainly provided with a first terminal apparatus 110 and second terminal apparatuses 210, which are included in the Internet 500.

The first terminal apparatus 110 is formed of a personal computer or the like disposed at an overseas photo shop 100, which is a photo shop in a travel destination, in terms of hardware. Then, various logical structure elements, which fulfill various functions related to the first terminal apparatus 110 explained next, are embodied by software. The first terminal apparatus 110 is connected to a data reading apparatus 120 for reading image data 10.

The second terminal apparatus 210 is formed of a personal computer or the like disposed at a domestic photo shop 200, which is a photo shop in a user's home country or in a third country, at a collection center, or at a service center. The plurality of second terminal apparatuses 210 disposed in this manner are arranged in the image data transmission system. Incidentally, there may be disposed only one second terminal apparatus 210 disposed in this manner. In the second terminal apparatus 210, various logical structure elements, which fulfill various functions related to the second terminal apparatus 210 explained next, are embodied by software.

The image data 10 is, for example, electrophotographic data (i.e. photographic data generated by taking a picture with a digital camera or video camera). As the format thereof, it may be based on JPEG (Joint Photographic Experts Group) standard, or it may be based on MPEG (Moving Picture Expert Group) standard.

As shown in FIG. 2, the first terminal apparatus 110 is provided with a first processing device 111 and a first communication device 112. The first processing device 111 is provided with a controller, a memory, and the like. The first communication device 112 is provided with a modem or the like.

As shown in FIG. 3, the second terminal apparatus 210 is provided with: a second processing device 211; a second communication device 212; a recording device 215; a status information generating device 216; and a selection device 217. The second processing device 211 includes a judgment device 213 and a selective error correction device 214. Each of the second processing device 211, the status information generating device 216, the selection device 217, the judgment device 213, and the selective error correction device 214 is provided with a controller, a memory, and the like. The second communication device 212 is provided with a modem or the like. The recording device 215 is provided with a controller, an optical pickup, or the like.

(1-2) Operation Principle (Generation of Communication Data)

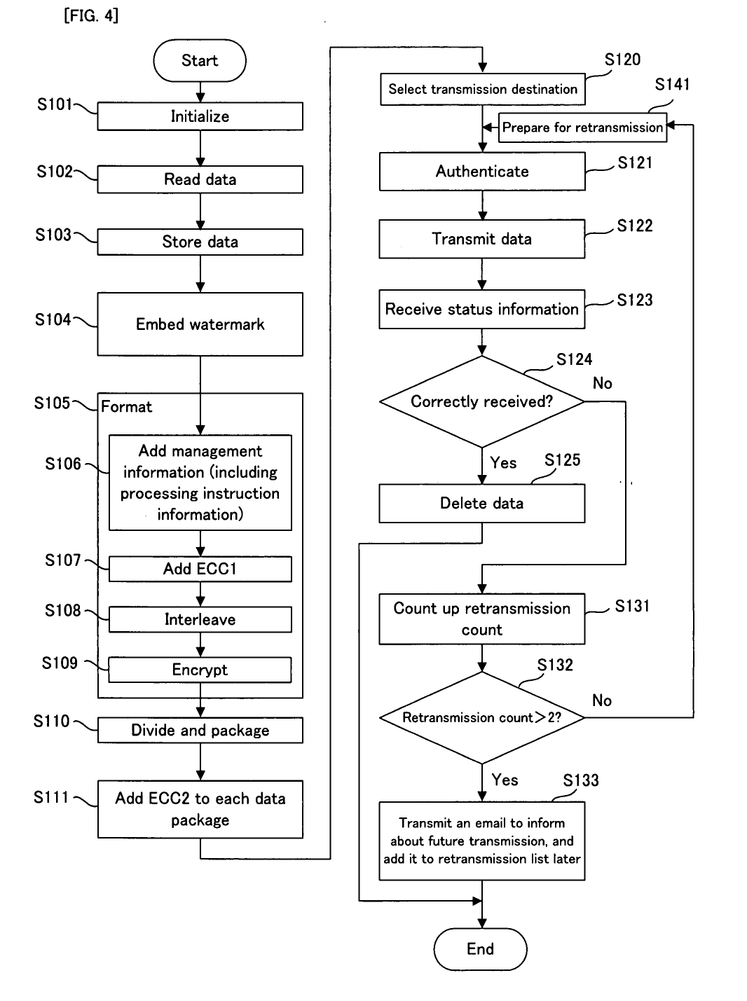

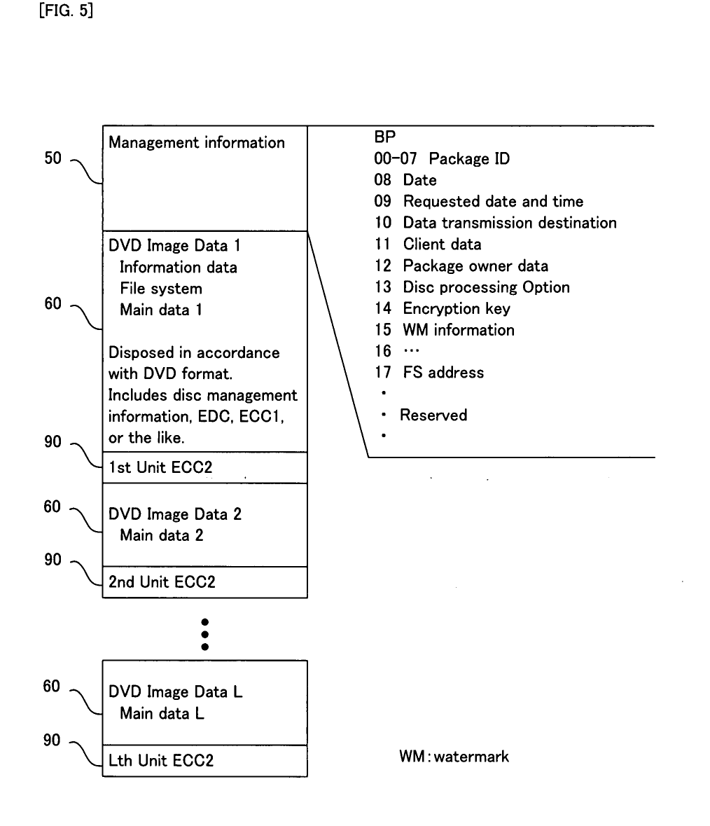

Next, with reference to the aforementioned FIG. 1 to FIG. 3 in addition to FIG. 4 and FIG. 5, an explanation will be given on the operation principle of generating communication data in the first embodiment of the present invention. FIG. 4 is a flowchart showing the operation principle of the first terminal apparatus side in the first embodiment. FIG. 5 is a conceptual view showing the structure of communication data in the first embodiment.

Here, as the operation related to the generation of the communication data, a step S102 to a step S111, which are in a former half portion of a flowchart shown in FIG. 4, are processed on the first terminal apparatus 110.

As shown in FIG. 4, firstly, on the first terminal apparatus 110 side, if the image data 10 is brought by a user, a flag register or the like of the first terminal apparatus 110 is initialized (step S101), and the image data 10 is loaded into the first terminal apparatus 110 through the data reading apparatus 120 (step S102). At this time, management information described later is also loaded, which is to manage the image data, such as various user identification information or the like which indicates user ID (Identification), name, address, phone number, and the like. Such management information may be inputted through an input device which is provided for the first terminal apparatus 110 and which has a key board, a mouse, an input pen, an audio input apparatus, or the like. Alternatively, such management information may be loaded into the first terminal apparatus 110 through an input port in a predetermined standard, from equipment, such as a user's memory card on which the image data 10 is recorded and a user's digital camera. Moreover, such management information may be loaded into the first terminal apparatus 110 through a port in a predetermined standard or by phone, from equipment which is not directly related to the image data 10, such as a user's mobile phone and mobile device. The loaded image data 10 and management information are stored in the recording medium, such as a hard disk, of the first terminal apparatus 110 (step S103).

Next, by the first processing device 111, watermark with a generation about a copyright holder is embedded or inserted into the image data 10 (step S104). That is, predetermined types of information, such as text information and digital information related to the image data, e.g. the name of the copyright holder, identification number, or the like, is embedded into the image data as the watermark such that some observer, who observes the images corresponding to the image data on a display, can hardly or cannot visually recognize it. The embedded watermark herein further includes the “generation”, and it has information which indicates where the image data 10 is in the generational order of copy.

Then, by the first processing device 111, a format process is performed on the image data 10 (step S105). As part of the format process, management information 50 for managing the image data is added to the image data 10 (step S106). As the management information 50, there are listed (1) various user identification information or ID information, which indicates user ID (Identification), name, address, phone number, or the like, for identifying memory card on which the image data is stored or a digital camera or the like which is related to the generation of the image data, (2) copyright holder management information which clearly specifies the copyright holder of the image data, (3) data type information which indicates which of photographic information, still image information, audio information, motion picture information, and the like the image data is related to, (4) date/time information which indicates a date/time when the image data is received, or date/time information which indicates a date/time when a photograph related to the image data is taken, (5) place information which clearly specifies a place where the image data is received, a place to which the image data is transmitted, and a place to which a printed photograph is transmitted, (6) processing information which indicates a basic process or a special process to be performed in the recording onto the recording medium, such as a DVD, like the presence or absence of color correction, contrast, and backlight correction, regarding the content of the image data, (7) content addition instruction information which indicates commercial music, photographs, or the like which are added, if desired, in the middle by the second terminal apparatus or a management center, (8) an individual encryption key used for encryption when the data is transmitted and received, (9) identification information or ID information about a data package which is managed by the management center, (10) date/time information which indicates a registration date/time to the management center, or the like. Moreover, history information, which indicates a history about recording of data input/output from the management center, a print-out process, disc generation, or the like, may be included in one portion of the management information. In addition to disc ID information and EDC (Error Detection Code) information, which comply with predetermined types of standards, such as a DVD standard, the information or the like that is at least one portion of disc management information or a file system, which is recorded by a unit of sector, is included in one portion of the management information herein. Preferably, the various management information, such as the user identification information and the copyright holder management information described above, is added to the image data 10 as the management information 50, which complies with the predetermined types of standards, such as a DVD standard, such that the various management information can be subsequently recorded and reproduced, as proper management information, as it is (or by slightly modifying it) on the recording medium, which complies with the predetermined types of standards, such as a DVD standard.

Moreover, particularly in the embodiment, processing instruction information is added as the management information 50, to instruct the second terminal apparatus 210 side to perform a processing process (step S106). The processing process instructed by the processing instruction information includes: adding appropriate background music to the image data 10, such as adding music in case of a slide show; adding an appropriate background image and image data which indicates a display image to the image indicated by the image data 10; or the like. Moreover, specific identification information about the music to be added (e.g. song title), identification information about the background image, and the like are also added as the processing instruction information.

Next, a first error correction code ECC1 for performing first error correction on the image data 10 in restoring is added to the image data 10 (step S107). The first error correction code ECC1 is an ECC which complies with the predetermined types of standards, such as a DVD standard. Incidentally, the first error correction code ECC1 may be added before or simultaneously with the addition of the management information 50.

Then, in the format process, an interleaving process, which complies with a DVD standard or the like, is performed on the image data 10 (step S108).

Then, in the format process, encryption, which complies with a DVD standard or the like, is performed on the image data 10 (step S109).

Then, by the first processing device 111, the image data 10 on which the format process is performed as described above is divided and packaged into fixed-data-length data package units, to thereby generate n data packages 60 (refer to FIG. 5) (wherein n is a natural number) (step Silo).

Then, by the first processing device 111, a second error correction code ECC2 (whose numerical reference is 90 in FIG. 5) for performing second error correction in restoring the data packages is added to each of the n data packages generated (step S111). The n data packages are fixed-data-length, so that it is possible to use the error correction code that enables the existing error correction, such as ECC. Incidentally, the size of the fixed-data-length data package unit is not particularly limited if it is suitable for the transmission through the communication network, such as the Internet 500 explained next.

By the aforementioned processes performed by the first processing device 111, the watermark with the generation is embedded into the image data 10, and the management information and the first error correction code ECC1 are added in the same format as or similar format to a DVD format to the image data 10 in which the watermark with the generation is embedded. Moreover, the communication data is generated as the n data packages to which the second error correction codes ECC2 are added by the data package unit.

(1-3) Structure of Communication Data

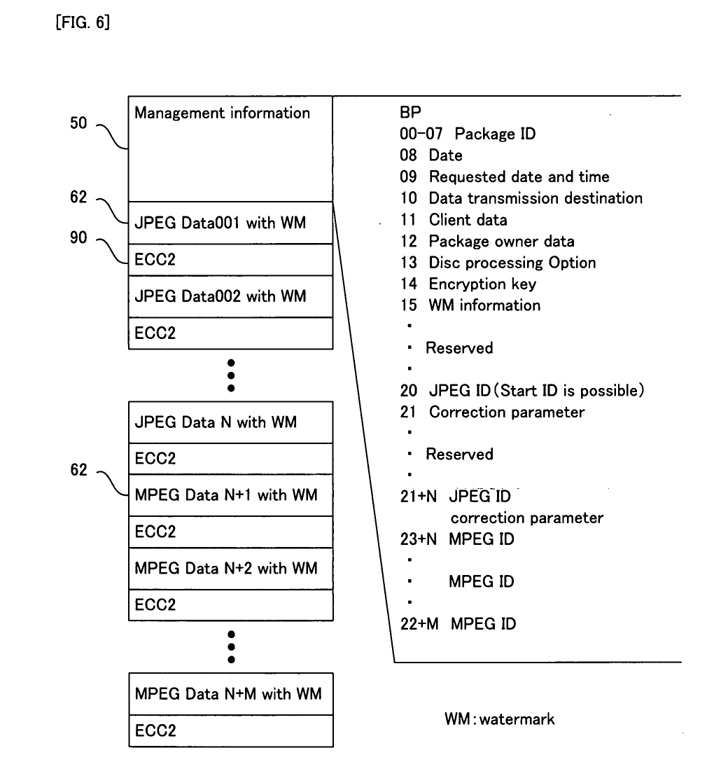

Next, with reference to FIG. 5 and FIG. 6, the structure of the communication data will be explained. FIG. 6 is a view showing the concept as in FIG. 5 in a modified example of the first embodiment. Incidentally, in FIG. 6, the same constituent elements as those in the first embodiment shown in FIG. 5 carry the same numerical references, and the explanation thereof will be omitted, as occasion demands.

As shown in FIG. 5, the communication data is formed of the management information 50, the data packages 60, and the second error correction codes ECC2 (whose numerical reference is 90 in FIG. 5). The management information 50 includes: the various user identification information, the copyright holder management information, the data type information, and the like, as described above. The data package 60 is generated by dividing and packaging the image data after the format process, as described above, and it is generated in the same format as or similar format to the DVD format. The second error correction code ECC2 (whose numerical reference is 90 in FIG. 5) is added to each of the data packages 60.

As shown as the modified example in FIG. 6, a data package 62 may be based on the JPEG standard, or it may be based on the MPEG standard. That is, in the aforementioned format process (the step S105 in FIG. 4), the formatting may be performed on the basis of the JPEG standard or the MPEG standard.

(1-4) Operation Principle (Transmission and Reception of Communication Data)

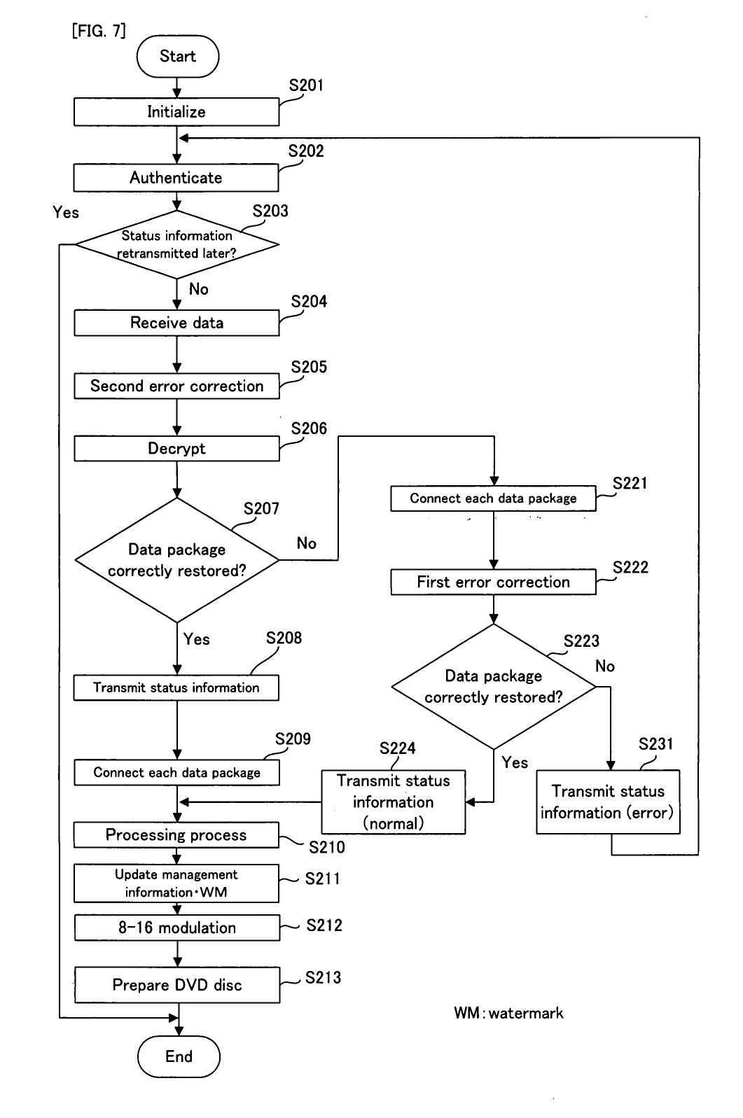

Next, with reference to FIG. 4, FIG. 5, and FIG. 7, an explanation will be given on the operation principle of the transmission and reception of the communication data in the first embodiment of the present invention. FIG. 7 is a flowchart showing the operation principle of the second terminal apparatus side in the first embodiment.

Here, as the operation related to the transmission and reception of the communication data, a step S120 to a step S133, which are in a latter half portion of the flowchart shown in FIG. 4, are processed on the first terminal apparatus 110. At the same time, a step S201 to a step S213 shown in FIG. 7 are processed on the second terminal apparatus 210.

As shown in FIG. 4, when the communication data is transmitted, the transmission destination of the communication data is firstly selected by the selection device 217 from the plurality of second terminal apparatuses 210 included in the Internet 500 (step S120). At this time, one as the transmission destination of the communication data generated in association with the image data brought by a user is selected in accordance with: geographical conditions related to the user and the shop; economic conditions, such as exchange rates; facility conditions in each shop, such as an order situation (or availability) in each domestic photo shop 200 in which the second terminal apparatus 210 is disposed and whether the shop has appropriate equipment; and user's desire and preferences. The selection here may be performed by the selection device 217 provided with a keyboard, a mouse, an input pen, an audio input apparatus, or the like, in accordance with an operation input performed by the user, clerk, or the like. Alternatively, it may be automatically performed by the selection device 217 on the basis of the management information 50 or the like. For example, the terminal apparatus 110 may always hold, in its built-in memory, order-indicator information which indicates an order situation in each domestic photo shop 200 and which is regularly or irregularly updated through the Internet 500 by the second terminal apparatus 210. In accordance with the stored updated order-indicator information, the first processing device 111 may select the photo shop 200 which has the minimum order. Alternatively, the first terminal apparatus 110 may obtain the order-indicator information from the second terminal apparatus 210 through the Internet 500 in real time before transmitting the communication data. In accordance with the order-indicator information, the first processing device 111 may select the photo shop 200. Moreover, the first processing device 111 may select a plurality of photo shops 200 which have the order less than a certain reference, and the user may select one of them through an input apparatus. Alternatively, one of the plurality of photo shops 200 which are on list on a screen of a display apparatus provided for the first terminal apparatus 110 may be selected by the user operating a mouse or the like. Therefore, the transmission destination of the communication data can be set, according to circumstances, to the second terminal apparatus 210 suitable for the user who is an owner of the image data 10, from among the plurality of second terminal apparatuses 210.

Next, authentication between the first terminal apparatus 110 and the second terminal apparatus 210 is performed by the first communication device 112 and the second communication device 210 between the both terminals through the Internet 500 (step S121). After that, the communication data generated as described above is transmitted to the second terminal apparatus 210 through the Internet 500 (step S122). Incidentally, as the communication network, a leased line network may be used instead of the Internet 500. As the authentication method here, the existing various authentication methods can be applied in which a password and code language are transmitted and received, for example. Thus, the first communication device 112 and the second communication device 210 firstly perform the authentication process by transmitting and receiving authentication information for the authentication, which is formed of at least one portion of the management information 50, or another authentication information before the transmission and reception of the communication data, and if they cannot authenticate each other, they stop the subsequent process. Incidentally, the authentication process may be performed immediately after the transmission and reception of the communication data.

On the other hand, as shown in FIG. 7, on the second terminal apparatus 210 side, a flag register or the like of the second terminal apparatus 210 is initialized (step S201), and the authentication with the first communication device 112 is performed (step S202). After that, by the second communication device 212 provided with a modem or the like, the communication data is received from the first terminal apparatus 110 through the Internet (step S204). At this time, even if the image data has a large data size, because the image data 10 is divided and packaged, it is possible to quickly transmit and receive the data, relatively highly reliably, by transmitting and receiving the plurality of or many data packages 60 in parallel.

Next, the second error correction is performed on the received communication data by the second processing device 211, which is provided with a controller, a memory, and the like, on the basis of the second error correction code ECC2 by the data package unit, to thereby restore the n data packages 60 (step S205). For example, the error correction is performed on the data packages by ECC. Since the n data packages are fixed-data-length, it is possible to perform relatively simple and highly reliable error correction here, such as ECC.

Then, a decryption process corresponding to the aforementioned encryption process (the step S109) is performed (step S206). Thus, the confidentiality of the communication data, which is transmitted and received through the Internet 500, can be significantly increased by the encryption process. As the encryption process, the existing various encryption processes using a public key and a private key or the like can be applied. Incidentally, with regard to such an encryption process, a compression process may be performed on the data packages, in addition to or instead of the encryption process.

Then, the restored n data packages 60 are connected by the recording device 215 provided with a controller, an optical pickup, or the like (step S209).

Then, the restored image data 10 is processed by the second processing device 211 in accordance with the processing instruction information included in the management information 50 added to the image data 10 (step S210). That is, for example, background music is added, a background image and a display image are added, or the like. While such a processing process is performed, the management information 50 may be updated in accordance with the processing process performed on the image data 10.

As described above, since the management information 50 including the processing instruction information is added to the image data 10, it is unnecessary to transmit, e.g., music information which is necessary to perform the processing process, with the image data 10. Transmitting content information, such as the music information for the processing process, with the image data, increases the amount of transmission, so that it is hardly possible to perform the quick or efficient transmission. In contrast, if an enormous amount of data for the processing process is intensively prepared in advance on the second terminal apparatus 210 side, then, the processing process can be performed quickly and efficiently by using the enormous amount of data for the processing process prepared in advance, as occasion demands, in accordance with the processing instruction information.

Then, the watermark with the generation, which is included in the image data 10, is updated by the second processing device 211 (step S211). The watermark with the generation is updated like the zero generation→the first generation→the second generation, and so on, in each time of the data copy on the second terminal apparatus. At this time, the management information 50, which is added to the image data 10, is also updated (the step S211).

Then, by the recording device 215, a modulation process, such as 8-16 modulation, is performed on the image data 10 which is formed of the data packages 60 in which the connection is completed (step S212). Incidentally, the transmission may be performed after the 8-16 modulation is performed on the first terminal apparatus 110 side; however, in this case, the data to be transmitted is approximately doubled, so that it is advantageous to perform the 8-16 modulation on the second terminal apparatus 210. Even if the modulation process is performed in this manner, the first error correction code ECC1 is valid as it is. Thus, when the image data 10 recorded on the recording medium is restored (in other words, reproduced), the first error correction can be effectively performed.

Then, the image data 10 on which the modulation process, such as 8-16 modulation, is performed is recorded by a recording apparatus 230 onto the recording medium, such as a DVD and an optical disc (step S213). At this time, the first error correction code ECC1 can be used for the first error correction when the image data recorded on the recording medium is restored (in other words, reproduced) later. Thus, the first error correction code ECC1 can be recorded, as one portion of the connected data packages, onto the recording medium together with the image data, as it is (i.e. with holding the relationship with the image data).

Moreover, the management information 50 is added to the image data 10 in compliance with the standard of the recording medium, such as a DVD standard, in advance. Thus, the management information 50 is also recorded, as one portion of the connected data packages, onto the recording medium together with the image data 10 and the first error correction code ECC1, as it is or after it is slightly modified or added. In the same manner, the watermark is embedded in the image data in compliance with the standard of the recording medium, such as a DVD standard, in advance. Thus, the watermark is also recorded onto the recording medium with the image data as it is (i.e. with holding the relationship with the image data) or after it is slightly modified, added, or updated. By these, when the image data recorded on the recording medium is restored (in other words, reproduced) later, the management information 50, which is added in advance on the first terminal apparatus 110 side, and the watermark, which is embedded in advance, can be used at least partially, so that it is possible to improve the efficiency as a whole.

In addition, since the processing process (the step S210) is performed on the image data 10 by the second processing device 211, eventually, the image data of higher added value than that of the original image data is provided in a form of a DVD or the like at a shop or the like in which the second terminal apparatus is disposed.

After that, at the domestic photo shop 200 in which the second terminal apparatus 210 is disposed, various related services are performed, such as holding and delivering the recording medium, on which the image data 10 having the watermark with the generation embedded is recorded with a part or all of the first error correction code ECC1 and the management information 50, printing out based on this, and delivering it.

As described above, if the first error correction code ECC1 is added in the same format as that of the recording medium, such as a DVD format, on the first terminal apparatus 110 side in advance, then, when the recording is performed on the recording medium on the second terminal apparatus 210 side, it is not necessary to change the first error correction code ECC1 in the restored data packages but it is only necessary to record it onto the recording medium, such as a DVD, so that it is useful. Moreover, with regard to the management information 50 other than the first error correction code ECC1, if it is added in the same format as that of the recording medium, such as a DVD format, then, it is unnecessary to modify the management information 50 on the second terminal apparatus 210 side, so that it is extremely useful. In the same concept, with regard to the addition (or recording) of the management information 50 to the image data 10, which is normally wide ranging, even if the format is not set to completely the same format of the recording medium, such as a DVD format, but if it is set to a similar format or the same format except blank space, i.e. if a template is used according to the format of the recording medium, such as a DVD format, then, the management information is hardly modified when the recording is performed onto the recording medium, such as a DVD, so that it is extremely useful.

In this case, on the second terminal apparatus 210 side, it is better either to record the management information 50 onto a partial hybrid disk having a format in which partial formatting is performed as the aforementioned template in advance, or to perform authoring and record the management information 50 onto a disk. For example, a hard disk may be prepared on the second terminal apparatus 210 side, and partial hybrid format data may be stored therein in advance as the template, and the image data 10 included in the data packages restored from the received communication data may be partially inserted herein. In any cases, with regard to the DVD-format ECC data, what is added before the transmission on the first terminal apparatus 110 side can be used, as it is, for the recording onto the recording medium. Thus, it is possible to perform the recording process, efficiently.

Moreover, since there is the watermark with the generation in the image data 10 as described above, appropriate protection is possible even if the image data 10, such as electrophotographic data which is related to an individual's privacy or which accompanies a copyright with a high proprietary nature, is stolen or lost in the process of its transmission and storage through the Internet 500. For example, even if it is stolen or lost, because the image data 10 has the watermark with the generation in a predetermined position, it can be judged by a legitimate copyright holder whether a copy is legal or illegal, including how many data copies preceded before it. At this time, a legitimate relation of right or legal relation, such as who the copyright related to the image data 10 shall belong to, is clarified from the association between the management information 50 and the watermark with the generation embedded in the image data 10.

As a result, it is possible to transmit the image data 10, such as electrophotographic data, through the Internet 500, relatively highly reliably and relatively efficiently. Thus, a shop in an overseas destination or the like to which the image data is brought by a user can realize such a service that the image data, such as the received electrophotographic data, is delivered to another shop in the user's home country.

As shown in FIG. 7, particularly in the embodiment, on the second terminal apparatus 121 side which receives the communication data, it is judged whether or not the n data packages are correctly restored by the second error correction (the step S205) by the judgment device 213 (step S207). Then, if it is judged that the n data packages are correctly restored by the second error correction (the step S205) by the judgment device 213 (the step S207: Yes), the first error correction is not performed. That is, the image data 10 can be restored from the data packages 60 even if the first error correction is not performed, so that it is avoided such waste that the first error correction is blindly performed. On the other hand, if it is judged that the n data packages are not correctly restored by the second error correction (the step S205) by the judgment device 213 (the step S207: No), the n data packages 60 are connected by the selective error correction device 214 (step S221). Then, in addition to the second error correction, the first error correction is performed on the received communication data (step S222). Therefore, even if an error frequency due to a transmission error or the like is high to the extent that it is beyond the correction by the second error correction, the first error correction code ECC1 added to each data package significantly increases the possibility that the error correction can be performed. Then, the error correction is performed by the first error correction (the step S222), and if the data packages are correctly restored (step S223: Yes), the recording is performed on the recording medium by the recording device 215 as usual. Incidentally, if the error correction cannot be performed by not only the second error correction but also the first error correction (the step S223: No), the recording by the recording device 215 is once stopped, and a retransmission process and a special process, such as outputting an error message to the exterior separately, are performed (step S231).

Moreover, after it is judged whether or not the data packages are correctly restored (the step S207, the step S223) as described above, status information is generated by the status information generation device 216, and it is transmitted by the second communication device 212, wherein the status information indicates whether or not the judgment device 213 judges that the data packages are correctly performed (the step S208, the step S224, and the step S231). On the other hand, as shown in FIG. 4, on the first terminal apparatus 110 side which has already transmitted the communication data, the status information is received by the first communication device 112 (step S123). Here, the status information, which indicates whether or not the judgment device 213 judges that the data packages are correctly performed, is generated with regard to at least m data packages which are not judged to be correctly restored, by the status information generation device 216, and it is transmitted by the second communication device 212 (the step S231). On the other hand, as shown in FIG. 4, on the first terminal apparatus 110 side which has already transmitted the communication data, if the status information is received by the first communication device 112 (the step S123), the m data packages which are not judged to be correctly restored in accordance with the content of the status information are retransmitted by the first communication device 112 (step S141). That is, (n-m) data packages which are judged to be correctly restored in accordance with the content of the status information are not retransmitted by the first communication device 112. Therefore, as compared with the case of the aspect that all the n data packages are retransmitted in the retransmission as described above, the amount of data related to the transmission and reception can be reduced, which allows the efficient data transmission.

Then, if it is judged that the data packages are correctly restored in accordance with the content of the status information (the step S124: Yes), the image data 10 corresponding to the already transmitted communication data is deleted by the first processing device 111 (step S125). That is, the image data 10 is deleted which exists on an arbitrary recording medium or memory medium on the first terminal apparatus 110 side. Incidentally, the original image data 10 on the recording medium, such as a memory card, brought by a user may be deleted.

In contrast, if it is not judged that the data packages are correctly restored in accordance with the content of the status information (the step S124: No), the image data 10 corresponding to the already transmitted communication data is not deleted by the first processing device 111. In this case, a retransmission process (step S131) described later and a special process, such as outputting an error message to the exterior separately (step S123), are performed. In any cases, a user can delete the image data 10 brought to a shop in an overseas travel destination or the like, relatively safely.

On the other hand, as shown in FIG. 4, on the first terminal apparatus 110 side which has already transmitted the communication data (the step S122), the status information is received by the first communication device 112 (the step S123). Then, if it is not judged that the data packages are not correctly restored in accordance with the content of the status information (step S114: No), the communication data corresponding to the n data packages is retransmitted by the first communication device 121 (the step S141). At this time, a retransmission count for recording the number of retransmissions is incremented by one count, i.e. it is counted up (the step S131). The retransmission here may be performed only once or a predetermined plurality of times. The retransmission timing may be immediate or after a lapse of a predetermined period (e.g. after 1 minute, 1 hour, 1 day, or the like). If the number of retransmissions exceeds a predetermined number of times (step S132: Yes), an e-mail is transmitted to inform about future transmission to the first terminal apparatus 110 side, and the data is added to a list to be retransmitted later (step S133).

Incidentally, without transmitting the status information from the second terminal apparatus 210 side as described above, simply, the same communication data may be transmitted twice or more from the first terminal apparatus 110 side. By virtue of such construction, it is possible to dramatically reduce the possibility that the communication data is not transmitted and received because of a transmission error or the like.

As a result, according to the first embodiment, the electrophotographic data can be transmitted through the communication network, such as the Internet 500, highly reliably and efficiently. In addition, it is possible to avoid such a situation that the original image data, which is important for a user, is mistakenly deleted.

### Second Embodiment

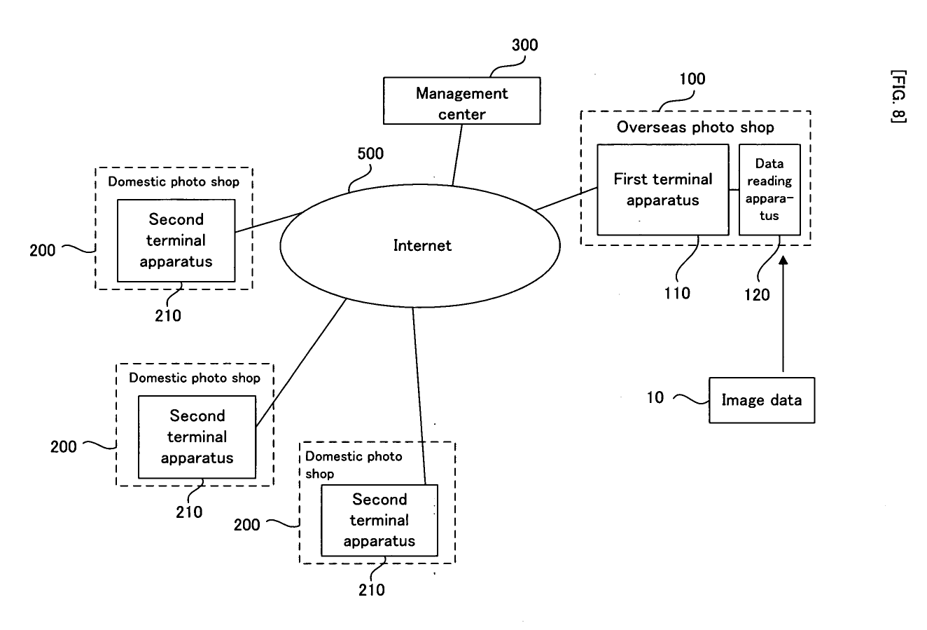

Next, with reference to FIG. 2 and FIG. 3 described above, as occasion demands, in addition to FIG. 8 to FIG. 10, the image data transmission system in a second embodiment will be explained.

(2-1) Basic Structure

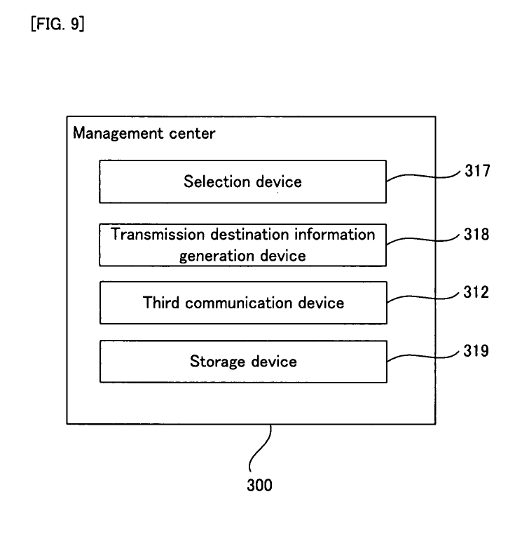

With reference to FIG. 8 and FIG. 9, an explanation will be given on the basic structure of the image data transmission system in the second embodiment of the present invention. FIG. 8 is a conceptual view showing the basic structure of the image data transmission system in the second embodiment. FIG. 9 is a block diagram showing the basic structure of the management center in the second embodiment. Incidentally, in FIG. 8, the same constituent elements as those in the first embodiment shown in FIG. 1 carry the same numerical references, and the explanation thereof will be omitted, as occasion demands.

As shown in FIG. 8, in the image data transmission system in the second embodiment, particularly, a management center 300 is included in the Internet 500. The other structure is the same as that in the first embodiment.

As shown in FIG. 9, the management center 300 is provided with: a third communication device 312; a selection device 317; a transmission destination information generation device 318; and a storage device 319. Each of the selection device 317 and the transmission destination information generation device 318 is provided with a controller, a memory, and the like. The third communication device 312 is provided with a modem or the like. The structure of each the first terminal apparatus 110 and the second terminal apparatus 210 is the same as that in the first embodiment.

(2-2) Operation Principle

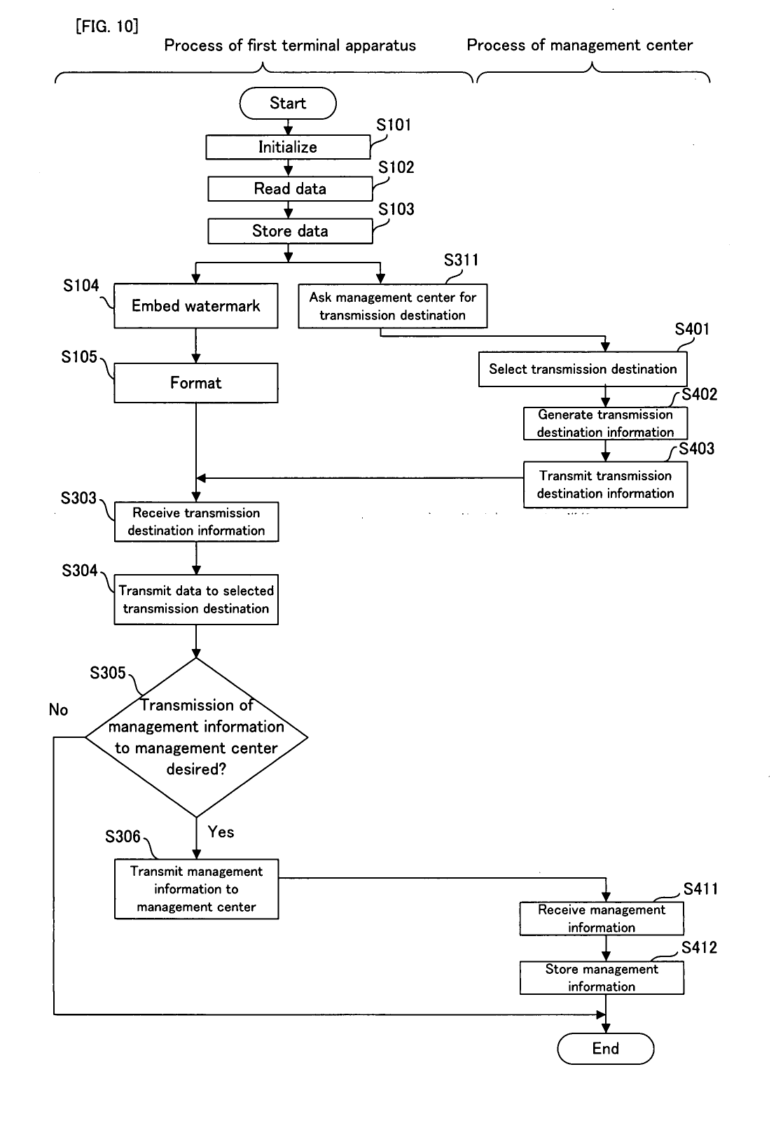

Next, with reference to FIG. 10, an explanation will be given on the operation principle of the first terminal apparatus and the management center in the second embodiment of the present invention. FIG. 10 is a flowchart showing the operation principle of the first terminal apparatus and the management center in the second embodiment. Incidentally, in FIG. 10, the same constituent elements as those in the first embodiment shown in FIG. 4 carry the same numerical references, and the explanation thereof will be omitted, as occasion demands.

As shown in FIG. 10, in the transmission and reception of the communication data, firstly, before the transmission and reception (step S304), the management center 300 is asked for the transmission destination of the communication data on the first terminal apparatus 110 side (step S311). Then, on the management center 300 side, one as the transmission destination of the communication data generated in association with the image data brought by a user is selected in accordance with the geographical conditions, the economic conditions, the order situation, and user's desire and the like described above, from among the plurality of second terminal apparatuses 210 included in the Internet 500 (step S401). The selection here is automatically performed by the selection device 317 on the basis of the management information 50 or the like. For example, the management center 300 may always hold, in one portion of the storage device 319, the order-indicator information which indicates an order situation in each domestic photo shop 200 and which is regularly or irregularly updated through the Internet 500 by the second terminal apparatus 210. In accordance with the stored updated order-indicator information, a third processing device 311 may select the photo shop 200 which has the minimum order. Alternatively, the management center 300 may obtain the order-indicator information from the second terminal apparatus 210 through the Internet 500 in real time before transmitting the communication data. In accordance with the order-indicator information, the third processing device 311 may select the photo shop 200. Moreover, the management center 300 may always hold, in one portion of the storage device 319, price information which indicates a price by considering exchange rates in each domestic photo shop 200 and which is regularly or irregularly updated through the Internet 500 by the second terminal apparatus 210. In accordance with the stored updated price information, the third processing device 311 may select the photo shop 200 which provides the cheapest price. Alternatively, the management center 300 may obtain the price information through the Internet 500 in real time from the second terminal apparatus 210. In accordance with the price information, the third processing device 311 may select the photo shop 200.

If one second terminal apparatus 210 is selected as the transmission destination in this manner, transmission destination information which indicates the selected one is generated by the transmission destination information generation device 318 (step S402). Moreover, the transmission destination information is transmitted by the third communication device 312 (step S403). Then, on the first terminal apparatus 110 side, the transmission destination information is received by the first communication device 112 (step S303). In accordance with the received transmission information, the communication data is transmitted to the selected one second terminal apparatus 210 without relaying the management center 300 (step S304). Therefore, the transmission destination of the communication data can be set, according to circumstances, to the second terminal apparatus 210 suitable for the user who is an owner of the image data 10, from among the plurality of second terminal apparatuses 210.

Incidentally, when the management center 300 performs the transmission, preferably, a tag (or electronic tag) is distributed to a user; for example, a tag is transmitted to a user's mobile phone. Then, this allows over-the-counter trading in accordance with identification by the exchange of the tag at the domestic photo shop 200 in which the second terminal apparatus 210 is disposed. In the identification in the over-the-counter trading, the management center 300 may be requested to distribute the tag. In addition, the management center may provide a progress about the recording service onto the recording medium, for a user who is a management target, by browsing or the like.

Next, on the first terminal apparatus 110 side, if the user desires the transmission of the management information 50 to the management center 300 (step S305: Yes), the management information 50 is transmitted to the management center 300 (step S306).

Then, the management center 300 receives the management information 50 (step S411), and stores it into the storage device 319 (step S412). Thus, the management center 300 only needs to perform the selection operation (the step S401) by using the selection device 317 with reference to the management information 50 stored in the storage device 319 without transmitting and receiving the image data or the like other than the management information 50. That is, the management center 300 only needs to perform so-called traffic control. On the other hand, the communication data is directly transmitted and received through the Internet 500, as described above, between the first terminal apparatus 110 and the second terminal apparatus 210 (step S304). That is, it is not necessary to relay the management center 300. Thus, it is possible to reduce a processing load at the management center 300, and it is possible to improve the efficiency as a whole.

### Third Embodiment

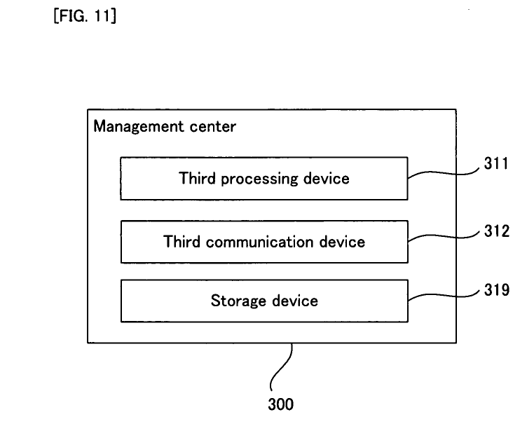

Next, with reference to FIG. 2, FIG. 3, and FIG. 8 described above in addition to FIG. 11 to FIG. 15, the image data transmission system in the third embodiment will be explained.

(3-1) Basic Structure

With reference to FIG. 2, FIG. 3, FIG. 8, and FIG. 11, an explanation will be given on the basic structure of the image data transmission system in the third embodiment of the present invention.

As shown in FIG. 8, the basic structure of the image data transmission system in the third embodiment is the same as that in the second embodiment, and the management center 300 is included in the Internet 500.

As shown in each of FIG. 2 and FIG. 3, the structures of the first terminal apparatus 110 and the second terminal apparatus 210 are the same as those in the second embodiment.

As shown in FIG. 11, the management center 300 is provided with the third processing device 311 in addition to the third communication device 312 and the storage device 319. The structure of each of the third communication device 312 and the storage device 319 is the same as that in the second embodiment. The third processing device 311 is provided with a controller, a memory, and the like.

(3-2) Operation Principle (Generation of Communication Data)

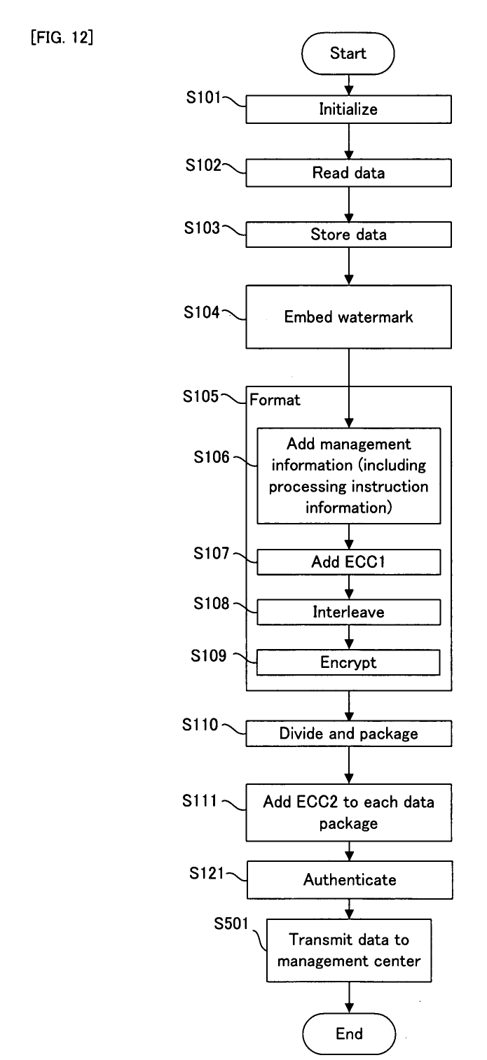

Next, with reference to FIG. 12, an explanation will be given on the operation principle of the generation of the communication data in the third embodiment of the present invention. FIG. 12 is a flowchart showing the operation principle of the first terminal apparatus in the third embodiment. Incidentally, in FIG. 12, the same constituent elements as those in the first embodiment shown in FIG. 4 carry the same numerical references, and the explanation thereof will be omitted, as occasion demands.

As shown in FIG. 12, on the first terminal apparatus 110 side, the watermark with a generation about a copyright holder is embedded into the image data 10 by the first processing device 111 (the step S104). Then, the format process is performed on the image data (the step S105). At this time, the management information for managing the image data is added to the image data (the step S106). The management information includes the processing instruction information, as in the first embodiment.

Then, after the authentication process is performed between the first terminal apparatus 110 and the management center 300 (the step S121), the communication data including not only the management information (including the processing instruction information) but also the image data is transmitted to the management center 300 (step S501).

(3-3) Structure of Communication Data

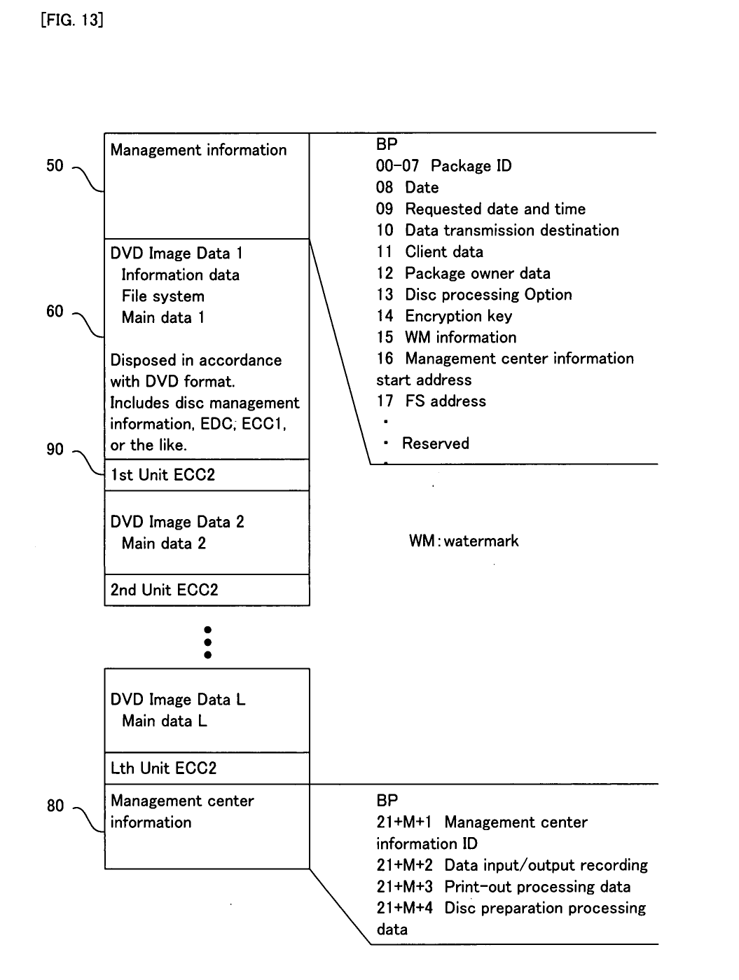

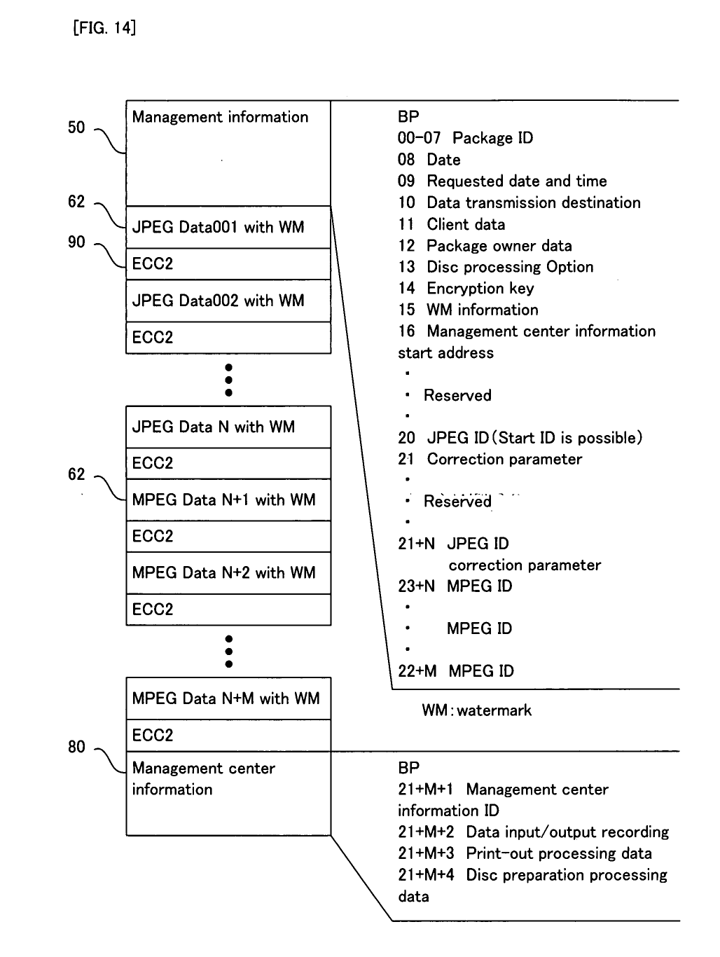

Next, with reference to FIG. 13 and FIG. 14, the structure of the communication data will be explained. FIG. 13 is a view showing the concept as in FIG. 5 in the third embodiment. FIG. 14 is a view showing the concept as in FIG. 6 in a modified example of the third embodiment.

As shown in FIG. 13, the communication data includes management center information 80. The other structure is the same as that of the communication data in the first embodiment.

The management center information 80 is a type of management information, in which a processing history at the management center is recorded, such as management center information ID, data input/output recording, print-out processing data, and disk generation processing data.

As shown in the modified example in FIG. 14, the communication data includes the management center information 80. As in the communication data in the modified example of the first embodiment, the data package 62 may be based on the JPEG standard, or it may be based on the MPEG standard.

(3-4) Operation Principle (Transmission and Reception of Communication Data, and Subsequent Process)

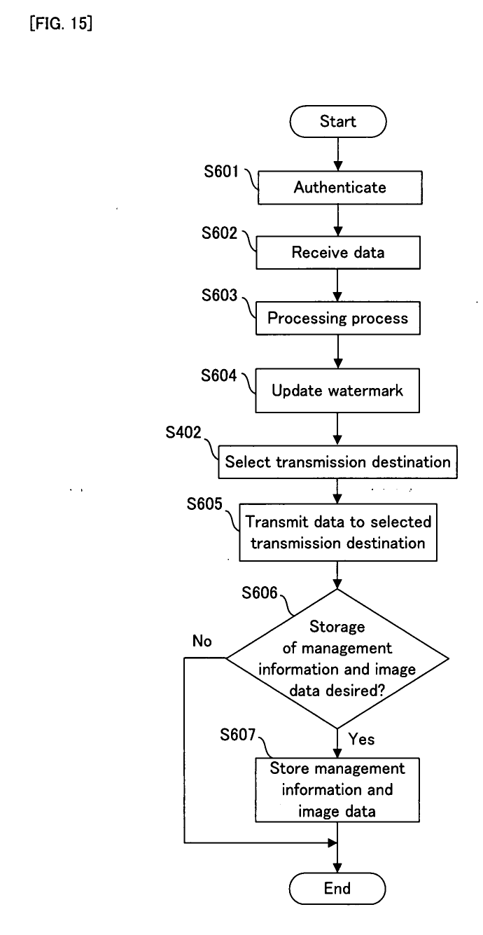

Next, with reference to FIG. 15, an explanation will be given on the transmission and reception of the communication data in the third embodiment of the present invention and a subsequent process. FIG. 15 is a flowchart showing the operation principle of the management center in the third embodiment. Incidentally, in FIG. 15, the same constituent elements as those in the second embodiment shown in FIG. 10 carry the same numerical references, and the explanation thereof will be omitted, as occasion demands.

Then, as shown in FIG. 15, after the management center 300 performs the authentication process between the management center 300 and the first terminal apparatus 110 (step S601), it receives the communication data (step S602).

Then, the image data included in the received communication data is processed by the third processing device 311 in accordance with the processing instruction information included in the added management information (step S603). That is, for example, background music is added, a background image and a display image are added, or the like. While such a processing process is performed, the management information may be updated in accordance with the processing process performed on the image data. As described above, since the management information including the processing instruction information is added to the image data, it is unnecessary to transmit, e.g., music information which is necessary to perform the processing process, with the image data. Transmitting content information, such as the music information for the processing process, with the image data, increases the amount of transmission, so that it is hardly possible to perform the quick or efficient transmission. In contrast, if an enormous amount of data for the processing process is intensively prepared in advance on the management center 300 side, then, the processing process can be performed quickly and efficiently by using the enormous amount of data for the processing process prepared in advance, as occasion demands, in accordance with the processing instruction information.

Then, the watermark with the generation, which is included in the received communication data, is updated by the third processing device 311 (the step S603). That is, with regard to the watermark with the generation, if the data is copied at the management center 300, it is updated like the zero generation→the first generation.

Then, one of the plurality of second terminal apparatuses 210 included in the Internet 500 is selected as the transmission destination (the step S402), and the image data, i.e. the communication data, in which the watermark with the generation updated by the third processing device is embedded and to which the updated or not-updated management information is added, is transmitted to the selected second terminal apparatus 210, which is the transmission destination, through the third communication device (step S604). That is, the communication data is transmitted from the first terminal apparatus 110 through the management center 300 to the selected one second terminal apparatus 210.

On the other hand, on the second terminal apparatus 210 side, with regard to the watermark with the generation, if the data is copied on the second terminal apparatus, then, this time, it is updated like the first generation→the second generation. As described above, since the image data has therein the watermark with the generation, which is updated at the management center 300 with a function as a relay station, it is possible to appropriately protect the image data, such as the electrophotographic data which is related to an individual's privacy or which accompanies a copyright with a high proprietary nature. Incidentally, with regard to the aspect of updating the information which indicates the generation, the updating may be performed by rewriting or additionally writing.

In addition, on the second terminal apparatus 210 side, the image data, on which the processing process is performed and which is included in the received communication data, is recorded onto the recording medium, such as a DVD and an optical disc, by the recording device 215, as in the first embodiment. Thus, eventually, the image data of higher added value than that of the original image data is provided in a form of a DVD or the like at a shop or the like in which the second terminal apparatus is disposed.

Then, as shown in FIG. 15, if a user desires (step S605), the management center 300 stores the communication data including not only the management information but also the image data, or the image data on which the processing process is performed or not performed, into a storage device 329 (step S606). Incidentally, the stored management information may be received separately from the communication data, or it may be restored from the received communication data. As described above, in the transmission and reception of the communication data, it is possible to transmit the data from the first terminal apparatus 110 to the second terminal apparatus 210, extremely safely and highly reliably by relaying the management center 300 provided with a highly-functional computer or the like. Moreover, with regard to the management of the image data and the management information after the data transmission, uniform management can be performed at the management center. Here, in particular, since the image data which is processed can be stored, the uniform management by the management center can be performed even on the image data to which background music is added.

Incidentally, in the image data transmission system in the third embodiment, the first processing device 111 performs the encryption process on the image data or the communication data, as in the first embodiment (the step S109). Then, the second processing device 211 and the management center 300 perform the decryption process corresponding to the encryption process, on the received communication data. Thus, it is significantly increase the confidentiality of the communication data, which is transmitted and received through the Internet 500, by virtue of the encryption process.

The present invention is not limited to the aforementioned embodiments, and various changes may be made, if desired, without departing from the essence or spirit of the invention which can be read from the claims and the entire specification. An image data transmission system and method, a terminal apparatus and a management center, which respectively constitute the transmission side and the reception side of the system, all of which involve such changes, are also intended to be within the technical scope of the present invention.

### INDUSTRIAL APPLICABILITY

The image data transmission system and method, the terminal apparatus and the management center, which respectively constitute the transmission side and the reception side of the system, according to the present invention can be applied to an image data transmission system and method, provided with a first terminal apparatus and a second terminal apparatus, wherein the first terminal apparatus is a personal computer or the like disposed at an overseas photo shop to which electrophotographic data is brought in an overseas destination or the like, and the second terminal apparatus is a personal computer or the like which is domestically included in the same communication network, such as the Internet, as that in the first terminal apparatus and which is disposed at a domestic photo shop, as well as such a first terminal apparatus, such a second terminal apparatus, and a management center.

1-15. (canceled)

16. An image data transmission system including a first terminal apparatus and a second terminal apparatus, which are included in a communication network,
(I) said first terminal apparatus comprising:
a first processing device for performing a first process including an addition process and an embedding process, on image data to be transmitted, to thereby generate communication data, the addition process adding management information, which includes copyright holder information about a copyright holder of the image data to manage the image data, the embedding process embedding watermark in mutual accordance with the management information, into each of a plurality of images corresponding to the image data; and
a first communicating device for transmitting the generated communication data through the communication network,
(II) said second terminal apparatus comprising:
a second communicating device for receiving the transmitted communication data through the communication network; and
a recording device for recording the received communication data or the image data to which the management information included in the received communication data is added and in which the watermark is embedded, onto a recording medium.

17. The image data transmission system according to claim 16, wherein
the embedding process embeds watermark with a generation having information which indicates where the image data is in a generational order of copy, as the watermark,
said second terminal apparatus further comprises:
a second processing device for updating the watermark with the generation, which is included in the received communication data, and
the recording device records the image data in which the watermark with the generation, which is updated by the second processing device, is embedded and to which the management information is added, onto a recording medium.

18. The image data transmission system according to claim 17, wherein
the communication network further includes a management center,
said management center comprises: (a) a third communicating device for receiving the communication data transmitted from the first communicating device through the communication network; and (b) a third processing device for updating the watermark with the generation, which is included in the received communication data,
the third communicating device newly transmits the image data in which the watermark with the generation, which is updated by the third processing device, is embedded and to which the management information is added, as the communication data, and
the second communicating device receives the communication data transmitted from the third transmitting device, in a form of relaying said management center through the communication network.

19. The image data transmission system according to claim 16, wherein
the management information includes processing instruction information which gives an instruction to perform a processing process to be performed on the image data to manage the image data,
said second terminal apparatus further comprises: a fourth processing device for performing the processing process indicated by the processing instruction information, on the image data in the received communication data, and
the recording device records the image data on which the processing process is performed, onto a recording medium in such a form that the management information is added.

20. The image data transmission system according to claim 16, wherein
the communication network further includes a management center,
the management information includes processing instruction information which gives an instruction to perform a processing process to be performed on the image data to manage the image data,
said management center comprises: (a) a third communicating device for receiving the communication data transmitted from the first communicating device, through the communication network; and (b) a fourth processing device for performing the processing process indicated by the processing instruction information, on the image data in the received communication data,
the third communicating device newly transmits the image data on which the processing process is performed and to which the management information is added, as the communication data, and
the second communicating device receives the communication data transmitted from the third transmitting device, in a form of relaying said management center through the communication network.

21. The image data transmission system according to claim 16, wherein said first terminal apparatus performs an authentication process by transmitting authentication information, which is formed of one portion of the management information, before transmitting the communication data, and said first terminal apparatus stops the transmission of the communication data if the authentication cannot be performed.

22. A first terminal apparatus, included in a communication network with a second terminal apparatus,
said first terminal apparatus comprising:
a first processing device for performing a first process including an addition process and an embedding process, on image data to be transmitted, to thereby generate communication data, the addition process adding management information, which includes copyright holder information about a copyright holder of the image data to manage the image data, the embedding process embedding watermark in mutual association with the management information, into each of a plurality of images corresponding to the image data; and
a first communicating device for transmitting the generated communication data through the communication network to said second terminal apparatus.

23. A second terminal apparatus, included in a communication network with a first terminal apparatus which performs a first process including an addition process and an embedding process, on image data to be transmitted, to thereby generate and transmit communication data, the addition process adding management information for managing the image data, the embedding process embedding watermark with a generation into each of a plurality of images corresponding to the image data, the watermark being mutually associated with the management information and having information which indicates where the image data is in a generational order of copy,
said second terminal apparatus comprising:
a second communicating device for receiving the transmitted communication data through the communication network;
a second processing device for updating the watermark with the generation, which is included in the received communication data; and
a recording device for recording the image data in which the watermark with the generation, which is updated by the second processing device, is embedded and to which the management information is added, onto a recording medium.

24. The image data transmission system according to claim 17, wherein
the management information includes processing instruction information which gives an instruction to perform a processing process to be performed on the image data to manage the image data,
said second terminal apparatus further comprises: a fourth processing device for performing the processing process indicated by the processing instruction information, on the image data in the received communication data, and
the recording device records the image data on which the processing process is performed, onto a recording medium in such a form that the management information is added.

25. The image data transmission system according to claim 18, wherein
the management information includes processing instruction information which gives an instruction to perform a processing process to be performed on the image data to manage the image data,
said second terminal apparatus further comprises: a fourth processing device for performing the processing process indicated by the processing instruction information, on the image data in the received communication data, and
the recording device records the image data on which the processing process is performed, onto a recording medium in such a form that the management information is added.

26. The image data transmission system according to claim 17, wherein
the communication network further includes a management center,
the management information includes processing instruction information which gives an instruction to perform a processing process to be performed on the image data to manage the image data,
said management center comprises: (a) a third communicating device for receiving the communication data transmitted from the first communicating device, through the communication network; and (b) a fourth processing device for performing the processing process indicated by the processing instruction information, on the image data in the received communication data,
the third communicating device newly transmits the image data on which the processing process is performed and to which the management information is added, as the communication data, and
the second communicating device receives the communication data transmitted from the third transmitting device, in a form of relaying said management center through the communication network.
